(19) United States
(12) Patent Application Publication
(10) Pub. No.: US 2020/0065759 A1
(43) Pub. Date: Feb. 27, 2020

(54) Method and Apparatus for Managing, Displaying, Analyzing, Coordinating, and Optimizing Innovation, Engineering, Manufacturing, and Logistics Infrastructures

(71) Applicant: Flextronics AP, LLC, San Jose, CA (US)

(72) Inventors: Michael M. McNamara, San Jose, CA (US); Thomas K. Linton, Newnan, GA (US); Nader K. Mikhail, Huntington Beach, CA (US)

(21) Appl. No.: 16/559,125

(22) Filed: Sep. 3, 2019

Related U.S. Application Data
(63) Continuation of application No. 14/453,788, filed on Aug. 7, 2014, now abandoned.
(60) Provisional application No. 61/863,303, filed on Aug. 7, 2013.

(51) Int. Cl. G06Q 10/08; G06Q 10/06

(52) U.S. Cl. CPC G06Q 10/0833; G06Q 10/0635

(57) ABSTRACT

The present disclosure discloses an engineering, manufacturing, supply chain and logistics operation management platform that can efficiently and effectively configure factors of product development, production, supply chains, and logistic operations and dynamically control such factors, supply chain and logistics to optimize performance. The platform will also provide the means of selectively and securely displaying data related to production factors, logistics, and supply chain to enable real-time monitoring to support the sales, financial management, or post sales process.

### CROSS REFERENCE TO RELATED APPLICATION

The present application is a continuation of and claims priority to U.S. patent application Ser. No. 14/453,788, filed Aug. 7, 2014, which claims the benefit of and priority, under 35 U.S.C. § 119(e), to U.S. Provisional Application Ser. Nos. 61/863,303, filed Aug. 7, 2013, of the same title, which is incorporated herein by this reference in its entirety.

### FIELD

The disclosure relates generally to automated systems for product management and particularly to automated platforms for designing, manufacturing, supplying, distributing, and maintaining products.

### BACKGROUND

The globalization of markets has brought new challenges to international businesses. Manufacturing, supply, and distribution is now done in multiple dislocated sites and markets, span multiple countries, each having unique regulatory requirements, political systems, and cultures, and can involve countless raw material and component suppliers and customers that collectively constitute the supply chain. These supply chain infrastructures are increasingly massive and complex and difficult to manage effectively, efficiently, and at low cost.

To cope with these massive and highly complex infrastructures, many global businesses, such as Apple™, Microsoft™, Amazon™, Google™, and Cisco™, outsource product design, manufacturing, and/or distribution to original equipment manufacturers (“OEMs”), such as Flextronics™, and act as the brand distributor for the products. OEMs service multiple brand distributors and therefore must adapt to different industries and product strategies within those industries. Notwithstanding outsourcing, execution or velocity of the supply chain (e.g., on-time product delivery) and product quality must continue to be maintained at high levels and supply chain operating costs at low levels.

Additional supply chain challenges result from the use of vastly different systems by suppliers and customers and the need to provide supplier and customer visibility into supply chain operation. Visibility is particularly difficult due to the use of vastly different computer and database systems by the various supply chain participants.

An added layer of complexity is caused by the need to recognize and adaptively respond to global changes in supply chain operating cost structures. Labor arbitrage is becoming an increasingly important factor in constructing supply chains. While, in the past, the supply chain moved to very low cost labor markets, such as India and China, labor price increases in these markets are now forcing supply chains to move to cheaper markets and even become more regionalized. An example is the migration of manufacturing operations for electronics products to historically high priced labor markets, such as Europe and the United States.

Supply chains further must cope with the reality that levels of product innovation are increasing, time-to-market requirements are shorter, and product life cycles are shorter. Disruptive technologies are increasing becoming a driving force of change in the marketplace.

### SUMMARY

These and other needs are addressed by the various aspects, embodiments, and/or configurations of the present disclosure. The present disclosure discloses discloses a resource management and reporting system for an enterprise or supply chain. It can include a platform for managing, displaying, analyzing, coordinating, and optimizing innovation, engineering, manufacturing, and logistics infrastructures. The platform can efficiently and effectively configure supply chains and logistic operations and dynamically manage and control supply chain and logistics performance.

The resource management and reporting system can include three resource management computational layers, namely the physical infrastructure reporting layer (e.g., a microprocessing structure comprising a microprocessor and computer readable medium), for a typical control tower, end-to-end services reporting layer (e.g., a microprocessing structure comprising a microprocessor and computer readable medium), and real-time information reporting layer (e.g., a microprocessing structure comprising a microprocessor and computer readable medium).

The physical infrastructure layer manages physical resources. Exemplary physical resources includes physical plant and equipment (e.g., manufacturing sites (e.g., plant and equipment), warehouses, inventory, office buildings and equipment, and other tangible assets) and employees, consultants, and contractors, which are located in various different countries and global in scale.

The end-to-end services layer manages services and operations (performed by the physical infrastructure layer) in the areas of product innovation, engineering, logistics, and supply chain configuration and performance.

The real-time information layer manages information related to the physical infrastructure and end-to-end services layers so as to provide, through various security protocols, real-time visibility into the information based on access privileges of the requestor, identify and proactively address risk, ensure efficient and cost effective execution, provide applications to provide services useful in execution of the end-to-end services layer, and provide cloud-based access by communication devices such as by personal, laptop, and tablet computers, smart phones and other cellular devices, personal digital assistants, and/or enterprise or organization communication devices, such as servers.

The information managed by the real-time information layer can be provided internally within the enterprise operating the platform (thereby offering better and quicker, more accurate quote generation and control and visibility of internal resources (whether labor or capital)), externally to unaffiliated customers (independent of the enterprise) (offering selected, secure and user customizable visibility into operations that impact the customer products), externally to unaffiliated suppliers (independent of the enterprise) (offering insight into the enterprise's needs, requirements and specifications), and internally to the enterprise (to capture the value chain from innovation to end of product life; that is, information about the innovation process (inventions and patents via a patent asset tracking system), design process and/or history (such as by an engineering managing and reporting application like Winchill™), logistics operations (such as by a logistics managing and reporting application like SimFlex™), and supply chain configuration and operations are interlinked and tied into physical/labor tracking systems (such as FlexFlow™ and Workday™)

The information is provided via a communication device and can be filtered and display formatted properly to reflect the requirements and restrictions of each communication device and thereby provide communication device awareness.

The platform can include various services modules. A security module can enforce provisions and policies adopted by a network administrator to prevent and monitor unauthorized access, misuse, modification, or denial of a trusted network and/or trusted network-accessible resources.

A physical infrastructure manager can manage physical resources located in various different countries and global in scale.

A cost monitoring module can monitor long term contract and spot market prices and/or costs on a selected object, such as materials and/or parts and/or components and/or products, labor, physical facilities (rental and/or purchase prices), transportation or shipment, and generates alarms or notifications when the monitored prices change upwards or downwards beyond specified thresholds and/or provides pricing or cost information to a supply chain and logistics analyzer for use in evaluating and recommending changes to a selected supply chain or logistics operation.

The supply chain and logistics analyzer can identify problems or choke points or bottlenecks in the supply chain and/or logistics operation(s) and/or provide recommended changes to the supply chain and/or logistics operation(s) to provide greater reliability, more reliable and faster material and/or part and/or component and/or product manufacture and delivery cycles, more material turns, and reduced cost and waste.

A supply chain and logistics manager can collect and store supply chain and/or logistics operation performance information, verify accuracy of scheduled delivery times, provide estimates of delivery times, identify potential manufacturing and delivery problems, and identify and quantify the effects of expected and unexpected events on supply chain and/or logistics performance. Examples of events adversely impacting supply chain and/or logistics performance include a natural disaster event, such as an earthquake, tsunami, volcanic eruption, fire, flood, avalanche, and/or landslide, a weather event, such as a storm, typhoon, hurricane, cyclone, tornado, wind, and/or blizzard, a political event, such as coup d'etate, sabotage, terrorism, act of war, military action, police action, embargo, and/or blockade, and a business event, such as a maritime vessel sinking, train derailment, freight vehicle wreck, device or system malfunction, criminal activity, airplane crash, labor disruption, lawsuit, financial insolvency, and/or bankruptcy. Events can be identified based on electronic information collected from an Internet search engine and/or Website. For example, event information can be collected from a server associated with one or more of a news source, a news aggregator, a weather data source, a governmental entity, a law enforcement authority, and a military authority.

An engineering services manager can provide product or component design services, product or component design scheduling, and monitoring of product or component design activities.

An information and retrieval and presentation module can receive, from the security module, requests for information, direct the requests to the appropriate services module, receive the response, determine the features and capabilities of the communication device originating the request, filter and format the response, according to predetermined rules, to comply with the features and capabilities of the communication device, and forward the filtered and formatted response to the communication device.

An innovation services module can identify, protect, and/or track patent protection of innovative ideas, inventions, modifications, adaptations, improvements, trade secrets, and other valuable information.

A risk manager can monitor a selected activity and determine and assign a risk parameter to a selected activity failing to satisfy one or more requirements, objectives, and/or specifications. The monitored activity can include, for example, a supply chain operation, a logistics operation, and a device or component design activity.

The platform can generate and/or implement a recommendation to mitigate the failure.

The platform can monitor securely and simultaneously multiple supply chains for different products (with performance information collected for each monitored supply chain being confidential to the respective monitored supply chain).

In one application, the resource management and reporting system is for an enterprise and/or supply chain and includes:

(a) a physical infrastructure reporting system operable to locate, monitor and/or manage physical resources in a supply chain and/or logistics operation of an enterprise and/or supply chain, the physical infrastructure reporting system comprising:
(i) a physical infrastructure manager to identify, locate, monitor, and manage enterprise and/or supply chain physical resources, other than inventory, the physical resources comprising physical plant and equipment and employees;

(b) an end-to-end services reporting system operable to manage enterprise and/or supply chain operations of and services performed by one or more of product innovation, engineering, supply chain, and logistics comprising:
(i) a plurality of readers at one or more warehouses to read a code or identifier associated with inventory as inventory is received and shipped, the code or identifier being one or more of a universal product code, radio frequency identifier, and electronic product code; and
   (ii) a supply chain and logistics manager to collect and/or store supply chain and/or logistics operation performance information based on inventory information received from the plurality of readers, verify accuracy of scheduled delivery times, provide estimates of delivery times, identify potential manufacturing and delivery problems, and/or identify and/or quantify the effects of expected and unexpected events on supply chain and/or logistics performance; and

(c) a real-time information reporting system operable to provide, over an untrusted network, enterprise and/or supply chain information received from the physical infrastructure and end-to-end services reporting systems to one or more client communication devices.

In another application, the resource management and reporting system includes:

(a) a physical infrastructure reporting system, comprising:
(i) a physical infrastructure manager to identify, locate, monitor, and manage enterprise physical resources, other than inventory, the physical resources comprising physical plant, equipment, and employees;

(b) an end-to-end services reporting system, comprising:
(i) a supply chain and logistics management system operable to locate, monitor and/or manage inventory in a supply chain and/or logistics operation of the enterprise and/or supply chain, the supply chain and logistics management system comprising:
(ii) a plurality of readers at one or more warehouses to read a code or identifier associated with inventory as inventory is received and shipped, the code or identifier being one or more of a universal product code, radio frequency identifier, and electronic product code;
(iii) a real-time location system comprising one or more satellite positioning system receivers to track shipments of products originating at or being shipped to the one or more warehouses; and
(iv) a supply chain and logistics manager to collect and/or store supply chain and/or logistics operation performance information based on inventory information received from the plurality of readers and the one or more satellite positioning system receivers, verify accuracy of scheduled inventory delivery times, provide estimates of inventory delivery times, identify potential manufacturing and delivery problems, and/or identify and/or quantify the effects of expected and unexpected events on supply chain and/or logistics performance;
(v) an engineering services manager to provide product or component design services, schedule product or component design, manage engineering processes, and/or monitor product or component design activities, the product or component being related to the inventory; and
(vi) an innovation services module to manage innovation processes and identify, protect, and/or track patent protection of valuable enterprise information related to the product or component;

(c) a real-time information reporting system to collect, manage, and report enterprise and/or supply chain information received from the physical infrastructure and end-to-end service reporting systems, comprising:
(i) a risk manager to monitor a selected enterprise and/or supply chain activity and determine and/or assign a risk parameter to the selected enterprise and/or supply chain activity failing to satisfy one or more requirements and/or specifications; and
(ii) an information retrieval and presentation module to provide substantial real-time enterprise and/or supply chain information and risk parameters to a portable communication device of an enterprise and/or supply chain representative.

The present disclosure can provide a number of advantages depending on the particular aspect, embodiment, and/or configuration. The platform can provide reliable execution, scalability, and value-added services, while controlling operating, overhead, and capital costs, in product design, manufacture, supply, distribution, and repair. It can manage economically complex and massive physical infrastructures manufacturing and distributing numerous different products in diverse global markets. It can efficiently manage innumerable independent suppliers and internal operations. It can enable personnel from vastly different cultures and political and regulatory environments and speaking different languages to work together closely, efficiently and collectively, while maintaining and respecting cultural and lingual differences and maintaining corporate social environment responsibility (“CSER”). It can leverage time zone differences to provide round-the-clock productivity. By making the operation and management of the supply chain more cost effective, it can reduce cost of goods sold and consumer prices, thereby increasing global price competition. It can maintain high levels of product innovation while also maintaining stringent time-to-market requirements and recognizing short product life cycles. It can be used by OEMs to service multiple brand distributors and adapt to different industries and product strategies within those industries. It can recognize and adaptively respond to global changes in supply chain operating cost structures. It can de-risk supply chains by maintaining low supply chain operating costs and high supply chain velocities (e.g., fast on-time product deliveries). It can, particularly for vertically integrated supply chains, more effectively and efficiently control suppliers, prices, product supply, and other terms, generate faster material turns or velocities, increase profit, enable leaner manufacturing and logistics operations, and reduce waste when compared to a supply chain without the platform. It can even enable OEMs, through servicing concurrently different industries, to cross-pollinate operating strategies across industries and thereby improve and fine-tune operating strategies within each industry. It can enable OEMs, through servicing concurrently different products in different industries, to apply one industry's value-add product adaptations to accommodate consumer changes to a completely different industry. It can integrate effectively vastly different systems by suppliers and customers and provide supplier and customer real-time visibility into supply chain operation. The visibility can be provided not only between different computational systems but also via portable devices, such as tablet computers, smart phones, and personal digital assistants. It can analyze national and multi-national supply chains, identify inefficiencies and faults, and redesign the supply chain into a more rational, efficient, and cost effective structure. It can provide a system that not only is fast, agile and responsive but also anticipates and reacts proactively to risks and other disruptive events in the supply chain. It can more effectively consider the impact of unanticipated or “black swan” events, including natural and manmade disasters, by monitoring news sources, law enforcement and military authorities, among others, and precisely mapping tier 1, 2, 3, and 4 facilities. It can effectively assess the sensitivity of the supply chain to various internal and external events. It can assess the risk of having a particular product or product component available at a selected location at a selected price or cost. It can enable greater levels of collaboration not only among the various supply chain tiers but also within tiers. It can enable more effective management of multiple sources, within a given tier, even for legally distinct, competitive entities. The system's combination of cloud tools, operating models, and risk management logic can create new, more profitable and effective business practices in three-dimensional supply chains.

These and other advantages will be apparent from the disclosure.

An “affiliate” refers to any person, partnership, joint venture, company or other form of enterprise which directly or indirectly controls, or is controlled by, or is under common control with, a party. “Control”, for purposes of this definition, means possession of the power to direct or cause the direction of management and policies through ownership of voting securities, contract, voting trust or otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Advanced planning and scheduling” (also referred to as APS and advanced manufacturing) refers to a manufacturing management process by which raw materials and production capacity are substantially optimally allocated to meet demand. APS is especially well-suited to environments where simpler planning methods cannot adequately address complex trade-offs between competing priorities. Production scheduling can be very difficult due to the (approximately) factorial dependence of the size of the solution space on the number of items/products to be manufactured.

“Automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

“Computer-readable medium” as used herein refers to any tangible and non-transient storage and/or transmission medium that participate in providing instructions to a processor for execution. Such a medium may take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium excludes transient storage media, particularly electrical, magnetic, electromagnetic, optical, magneto-optical signals.

“Critical path method” refers to an algorithm for scheduling a set of project activities. CPM constructs a model of the project that includes the following: (a) a list of all activities required to complete the project (typically categorized within a work breakdown structure), (b) the time (duration) that each activity will take to completion, and (c) the dependencies between the activities. Using these values, CPM calculates the longest path of planned activities to the end of the project, and the earliest and latest that each activity can start and finish without making the project longer. This process determines which activities are “critical” (i.e., on the longest path) and which have “total float” (i.e., can be delayed without making the project longer). In project management, a critical path is the sequence of project network activities which add up to the longest overall duration. This determines the shortest time possible to complete the project. Any delay of an activity on the critical path directly impacts the planned project completion date (i.e. there is no float on the critical path). A project can have several, parallel, near critical paths. An additional parallel path through the network with the total durations shorter than the critical path is called a sub-critical or non-critical path.

A “database” is an organized collection of data held in a computer. The data is typically organized to model relevant aspects of reality (for example, the availability of specific types of inventory), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multivalue, semantic, and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented, and unstructured databases.

“Database management systems” (DBMSs) are specially designed applications that interact with the user, other applications, and the database itself to capture and analyze data. A general-purpose database management system (DBMS) is a software system designed to allow the definition, creation, querying, update, and administration of databases. Well-known DBMSs include MySQL™, PostgreSQL™, SQLite™, Microsoft SQL Server™ Microsoft Access™, Oracle™, SAP™, dBASE™ FoxPro™ and IBM DB2™. A database is not generally portable across different DBMS, but different DBMSs can inter-operate by using standards such as SQL and ODBC or JDBC to allow a single application to work with more than one database.

“Determine”, “calculate” and “compute,” and variations thereof, as used herein, are used interchangeably and include any type of methodology, process, mathematical operation or technique.

An “Electronic Product Code” (EPC) is designed as a universal identifier that provides a unique identity for every physical object anywhere in the world, for all time. Its structure is defined in the EPCglobal Tag Data Standard, which is an open standard freely available for download from the website of EPCglobal, Inc. The canonical representation of an EPC is a URI, namely the “pure-identity URI” representation that is intended for use when referring to a specific physical object in communications about EPCs among information systems and business application software. The EPCglobal Tag Data Standard also defines additional representations of an EPC identifier, such as the tag-encoding URI format and a compact binary format suitable for storing an EPC identifier efficiently within RFID tags (for which the low-cost passive RFID tags typically have limited memory capacity available for the EPC/UII memory bank). The EPCglobal Tag Data Standard defines the structure of the URI syntax and binary format, as well as the encoding and decoding rules to allow conversion between these representations. The EPC is designed as a flexible framework that can support many existing coding schemes, including many coding schemes currently in use with barcode technology. EPCs are not designed exclusively for use with RFID data carriers. They can be constructed based on reading of optical data carriers, such as linear bar codes and two-dimensional bar codes, such as Data Matrix symbols. The “pure identity URI” canonical representation of an EPC is agnostic to the data carrier technology that was used to attach the unique identifier to the individual physical object.

An “enterprise” refers to a business and/or governmental organization, such as a corporation, partnership, joint venture, agency, military branch, and the like.

“Enterprise resource planning” or ERP systems integrate internal and external management information across an entire organization, embracing finance/accounting, manufacturing, sales and service, customer relationship management, and the like. ERP systems automate this activity with an integrated software application. The purpose of ERP is to facilitate the flow of information between all business functions inside the boundaries of the organization and manage the connections to outside stakeholders.

“Internet search engine” refers to a web search engine designed to search for information on the World Wide Web and FTP servers. The search results are generally presented in a list of results often referred to as SERPS, or “search engine results pages”. The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™, store every word of every page they find.

“Manufacturing process management” or MPM is a collection of technologies and methods used to define how products are to be manufactured. MPM differs from ERP/MRP, which is used to plan the ordering of materials and other resources, set manufacturing schedules, and compile cost data. A cornerstone of MPM is the central repository for the integration of all these tools and activities aids in the exploration of alternative production line scenarios; making assembly lines more efficient with the aim of reduced lead time to product launch, shorter product times and reduced work in progress (WIP) inventories as well as allowing rapid response to product or product changes.

“Material requirements planning” or MRP is a production planning and inventory control system used to manage manufacturing processes. Most MRP systems are software-based. An MRP system is intended to simultaneously meet three objectives, namely ensure materials are available for production and products are available for delivery to customers, maintain the lowest possible material and product levels in store, and plan manufacturing activities, delivery schedules and purchasing activities.

“Means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

“Module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

An “original equipment manufacturer”, or OEM, manufactures product or components that are purchased by another enterprise and retailed under that purchasing enterprise's brand name. OEM refers to an enterprise that originally manufactured the product. When referring to automotive parts for instance, OEM designates a replacement part made by the manufacturer of the original part.

“Queueing theory” refers to algorithms for characterizing or defining the behavior of queues. Queueing theory is generally considered a branch of operations research because the results are often used when making business decisions about the resources needed to provide service. A queueing model based on the Poisson process and its companion exponential probability distribution often meets these two requirements. A Poisson process models random events (such as a customer arrival, a request for action from a web server, or the completion of the actions requested of a web server) as emanating from a memoryless process. That is, the length of the time interval from the current time to the occurrence of the next event does not depend upon the time of occurrence of the last event. In the Poisson probability distribution, the observer records the number of events that occur in a time interval of fixed length. In the (negative) exponential probability distribution, the observer records the length of the time interval between consecutive events. In both, the underlying physical process is memoryless. Examples of queueing theory functions or principals include BCMP network, Buzen's algorithm, Ehrenfest model, fork-join queue, Gordon-Newell network, Jackson network, Little's law, Markovian arrival processes, Pollaczek-Khinchine formula, quasireversibility, random early detection, renewal theory, the Poisson process, and the like. Models based on the Poisson process often respond to inputs from the environment in a manner that mimics the response of the system being modeled to those same inputs. The analytically tractable models that result yield both information about the system being modeled and the form of their solution. Even a queueing model based on the Poisson process that does a relatively poor job of mimicking detailed system performance can be useful. The fact that such models often give “worst-case” scenario evaluations appeals to system designers who prefer to include a safety factor in their designs. The form of the solution of models based on the Poisson process often provide insight into the form of the solution to a queueing problem whose detailed behavior is poorly mimicked. As a result, queueing models are frequently modeled as Poisson processes through the use of the exponential distribution.

“Real-time locating systems” or RTLS are used to automatically identify and track the location of objects or people in real time, usually within a building or other contained area. Wireless RTLS tags are attached to objects or worn by people, and in most RTLS, fixed reference points receive wireless signals from tags to determine their location. Examples of real-time locating systems include tracking automobiles through an assembly line, locating pallets of merchandise in a warehouse, or finding medical equipment in a hospital. The physical layer of RTLS technology is usually some form of radio frequency (RF) communication, but some systems use optical (usually infrared) or acoustic (usually ultrasound) technology instead of or in addition to RF. Tags and fixed reference points can be transmitters, receivers, or both, resulting in numerous possible technology combinations. RF trilateration can use estimated ranges from multiple receivers to estimate the location of a tag. RF triangulation uses the angles at which the RF signals arrive at multiple receivers to estimate the location of a tag.

“Scheduling algorithms” refer to production scheduling and includes forward and/or backward scheduling. Forward scheduling is planning the tasks from the date resources become available to determine the shipping date or the due date. Backward scheduling is planning the tasks from the due date or required-by date to determine the start date and/or any changes in capacity required. Stochastic scheduling algorithms include economic lot scheduling problem (which is concerned with scheduling the production of several products on a single machine in order to minimize the total costs incurred (which include setup costs and inventory holding costs) and the economic production quantity model (which determines the quantity a enterprise and/or organization and/or retailer should order to minimize the total inventory costs by balancing the inventory holding cost and average fixed ordering cost). Examples of heuristic algorithms include the modified due date scheduling heuristic (which assumes that the objective of the scheduling process is to minimize the total amount of time spent on tasks after their due dates) and shifting bottleneck heuristic (which minimize the time it takes to do work, or specifically, the makespan in a job shop, wherein the makespan is defined as the amount of time, from start to finish, to complete a set of multi-machine jobs where machine order is pre-set for each job, the jobs are assumed to be actually competing for the same resources (machines) resulting in one or more resources acting as a ‘bottleneck’ in the processing, whereby the heuristic, or ‘rule of thumb’ procedure substantially minimizes the effect of the bottleneck).

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running. Servers commonly operate within a client-server architecture, in which servers are computer programs running to serve the requests of other programs, namely the clients. The clients typically connect to the server through the network but may run on the same computer. In the context of Internet Protocol (IP) networking, a server is often a program that operates as a socket listener. An alternative model, the peer-to-peer networking module, enables all computers to act as either a server or client, as needed. Servers often provide essential services across a network, either to private users inside a large organization or to public users via the Internet.

“Simulation modeling” refers both to discrete and continuous simulations. Discrete simulations are also known as discrete event simulations, and are event-based dynamic stochastic systems. In other words, the system contains a number of states, and is modeled using a set of variables. If the value of a variable changes, this represents an event, and is reflected in a change in the system's state. As the system is dynamic, it is constantly changing, and because it is stochastic, there is an element of randomness in the system. Representation of discrete simulations is performed using state equations that contain all the variables influencing the system. Continuous simulations also contain state variables; these however change continuously with time. Continuous simulations are usually modeled using differential equations that track the state of the system with reference to time. The simulation's output data will only produce a likely estimate of real-world events. Methods to increase the accuracy of output data include: repeatedly performing simulations and comparing results, dividing events into batches and processing them individually, and checking that the results of simulations conducted in adjacent time periods “connect” to produce a coherent holistic view of the system. Normal analytical techniques make use of extensive mathematical models which require assumptions and restrictions to be placed on the model. This can result in an avoidable inaccuracy in the output data. Simulations avoid placing restrictions on the system and also take random processes into account; in fact in some cases simulation is the only practical modeling technique applicable.

“Transfer Function” (also known as the system function or network function) is a mathematical representation, in terms of spatial or temporal frequency, of the relation between the input and output of a linear time-invariant system with zero initial conditions and zero-point equilibrium. Transfer functions are commonly used in the analysis of systems such as single-input single-output filters. The term is often used to refer to linear, time-invariant systems (LTI). Most real systems have non-linear input/output characteristics, but many systems, when operated within nominal parameters (not “over-driven”) have behavior that is close enough to linear that LTI system theory is an acceptable representation of the input/output behavior. While any LTI system can be described by some transfer function or another, there are certain families of special transfer functions that are commonly used. Typical infinite impulse response filters are designed to implement one of these special transfer functions. Some common transfer function families and their particular characteristics are: Butterfield filter—maximally flat in passband and stopband for the given order; Chebyshev filter (Type I)—maximally flat in stopband, sharper cutoff than Butterworth of same order; Chebyshev filter (Type II)—maximally flat in passband, sharper cutoff than Butterworth of same order; Bessel filter—best pulse response for a given order because it has no group delay ripple; Elliptic filter—sharpest cutoff (narrowest transition between pass band and stop band) for the given order; Optimum “L” filter; Gaussian filter—minimum group delay and gives no overshoot to a step function; Hourglass filter; and Raised-cosine filter.

“Transportation theory” refers to the study of optimal transportation and allocation of resources. The transportation problem as it is stated in modern or more technical literature looks somewhat different because of the development of Riemannian geometry and measure theory. Examples of transportation theory functions or principals include Wassertein metric, transport function, and the Hungarian algorithm.

A “warehouse management system” (WMS) is a part of the supply chain and controls the movement and storage of materials or inventory within a warehouse and processes the associated transactions, including shipping, receiving, putaway and picking. The systems can also direct and optimize stock putaway based on real-time information about the status of bin utilization. A WMS monitors the progress of products through the warehouse. It involves the physical warehouse infrastructure, tracking systems, and communication between product stations. Commonly, warehouse management involves the receipt, storage and movement of goods, (normally finished goods), to intermediate storage locations or to a final customer. In the multi-echelon model for distribution, there may be multiple levels of warehouses. This includes a central warehouse, a regional warehouses (serviced by the central warehouse) and potentially retail warehouses (serviced by the regional warehouses). Warehouse management systems often utilize automatic identification and data capture technology, such as barcode scanners, mobile computers, wireless LANs and potentially radio-frequency identification (RFID), to efficiently monitor the flow of products. Once data has been collected, there is either a batch synchronization with, or a real-time wireless transmission to a central database. The database can then provide useful reports about the status of goods in the warehouse.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a diagram of a platform architecture according to an embodiment;

FIG. 2 is a block diagram of an exemplary three-dimensional supply chain;

FIG. 3 is a block diagram of an exemplary supply chain management system;

FIG. 4 is a block diagram of an exemplary control tower services platform;

FIG. 5 is a block diagram of an exemplary control tower services platform;

FIG. 6 is a block diagram of an exemplary physical infrastructure manager;

FIG. 7 is a block diagram of an exemplary supply chain and logistics manager;

FIG. 8 is a block diagram of an exemplary engineering services manager;

FIG. 9 depicts a screenshot according to an embodiment;

FIG. 10 depicts a screenshot according to an embodiment;

FIG. 11 depicts a screenshot according to an embodiment;

FIG. 12 depicts a screenshot according to an embodiment;

FIG. 13 depicts a screenshot according to an embodiment;

FIG. 14 depicts a screenshot according to an embodiment;

FIG. 15 is a flow chart of an exemplary security module;

FIG. 16 is a flow chart of an exemplary physical infrastructure manager;

FIG. 17 is a flow chart of an exemplary physical infrastructure manager;

FIG. 18 is a flow chart of an exemplary physical infrastructure manager;

FIG. 19 is a flow chart of an exemplary cost monitoring module;

FIG. 20 is a flow chart of an exemplary supply chain and logistics analyzer;

FIG. 21 is a flow chart of an exemplary data collection and maintenance module;

FIG. 22 is a flow chart of an exemplary scheduling module;

FIG. 23 is a flow chart of an exemplary analytical engine;

FIG. 24 is a flow chart of an exemplary engineering services manager;

FIG. 25 is a flow chart of an exemplary information retrieval and presentation module; and

FIG. 26 is a flow chart of an exemplary risk manager.

### DETAILED DESCRIPTION

### Overview of the Control Tower Services Platform

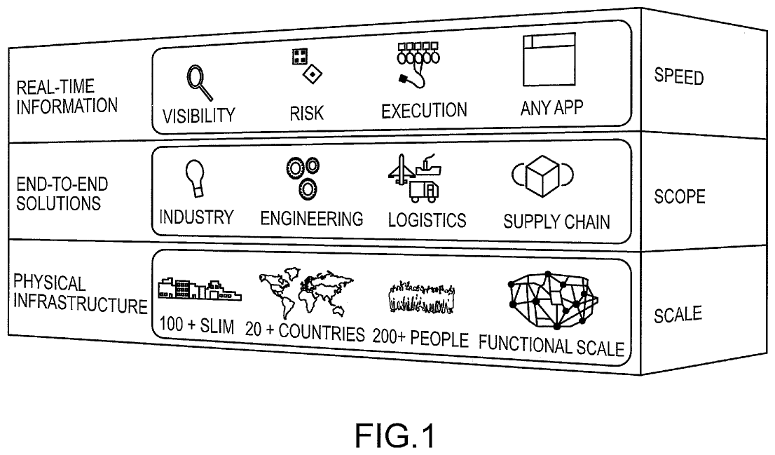

The control tower services platform will be described conceptually with respect to FIG. 1. FIG. 1 depicts three resource management layers of the platform, namely the physical infrastructure reporting layer, end-to-end services reporting layer, and real-time information reporting layer, for a typical control tower and the objective of each layer, namely the geographic scale of the physical resources for the physical infrastructure layer, operational scope of the enterprise and its component parts for the end-to-end services or solutions layer, and speed of information collection and transmission for the real-time information layer. The physical infrastructure layer collects and processes information and manages physical resources. Exemplary physical resources includes physical plant and equipment (e.g., manufacturing sites (e.g., plant and equipment), warehouses, inventory, office buildings and equipment, and other tangible assets) and employees, consultants, and contractors, which are located in various different countries and global in scale. The end-to-end services layer collects and processes information and manages services and operations (performed by the physical infrastructure layer) in the areas of product innovation, engineering, logistics, and supply chain. The real-time information layer collects and manages information related to the physical infrastructure and end-to-end services layers so as to provide, through various security protocols, real-time visibility into the information based on access privileges of the requestor, identify and proactively address risk, ensure efficient and cost effective execution, provide applications to provide services useful in execution of the end-to-end services layer, and provide cloud-based access, such as by personal, laptop, and tablet computers, smart phones and other cellular devices, personal digital assistants, and/or enterprise or organization communication devices, such as servers (hereinafter “client communication devices”). The information provided, via a client communication device, can be filtered and display formatted properly to reflect the requirements and restrictions of each client communication device and thereby provide client communication device awareness. The information can be pushed to and/or pulled by the client communication device.

### The Control Tower Services Platform 150

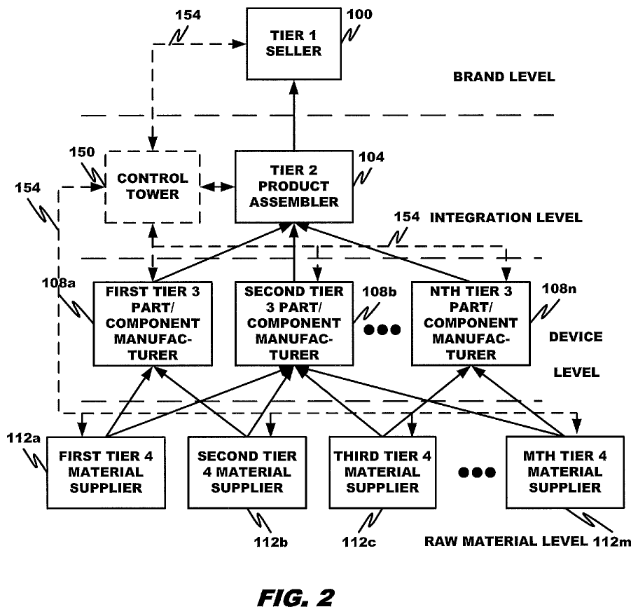

The conceptual interaction of the control tower services platform will be discussed with reference to FIG. 2. Generally, parts and components are made from materials and/or other parts and components, and products are made from material, parts, and/or components. Materials are generally considered to be raw materials, or crude or processed materials or substances.

A tier 1 seller, in a brand level, typically corresponds to a retail and/or wholesale vendor, supplier, distributor, or other business that provides its branded products to end users. These businesses typically invest in research and development, product design, marketing, and brand development. Examples include Apple™, Amazon™, Cisco Systems, Inc.™, and Microsoft Corporation™.

A tier 2 product assembler 104, in an integration level, assembles parts and/or components received from tier 3 part and/or component manufacturers into products, which are shipped to the tier 1 vendor, supplier, distributor, or other business for sale. An OEM is an example of a Tier 2 product assembler 104. Tier 2 product assembler(s) 104 provide, to the tier 1 control tower 100, its respective performance information and performance information received from tier 3 part and/or component manufacturers.

The first, second, . . . nth tier 3 part and/or component manufacturers 108a-n, at the device level, manufacture parts and/or components for assembly by the tier 2 product assembler 104 into products. The first, second, . . . nth tier 3 part and/or component manufacturers 108a-n provide, to the tier 2 product assembler 104, its respective performance information and performance information received from tier 4 material suppliers.

The first, second, third, . . . mth tier 4 material suppliers 112a-m, at the raw material level, manufacture and supply to the first, second, . . . nth their 3 part and/or component manufacturers 108a-n materials for use in manufacturing components. The first, second, third, . . . mth tier 4 material suppliers 112a-m provide, to the tier 3 part and/or component manufacturers, its respective performance information.

Each of the tier 1 seller 100, tier 2 product assembler 104, first, second, third, . . . nth tier 3 part and/or component manufacturer, and first, second, third, . . . mth tier 4 material suppliers 112a-m can correspond to an enterprise and/or organization, which may or may not be related to or affiliated with another enterprise and/or organization in the supply chain of FIG. 1. In some vertically integrated applications, multiple of the tier 1 seller 100, tier 2 product assembler 104, first, second, third, . . . nth tier 3 part and/or component manufacturer, and first, second, third, . . . mth tier 4 material suppliers 112a-m are part of a common enterprise and/or organization.

As shown by the arrows, air, land, and sea logistics providers, such as FedEx, UPS, DHL, other trucking companies, other air freight companies, and other ocean freight carriers, link the various tier partners with an integrated network of air, sea, and ground capabilities to enable effective movement of materials, components, and products from sources to destinations.

The control tower services platform 150, via communication links 154, monitors (and collects information regarding) the product distribution chain, product inventory levels, product demand, and/or prices of competitive products and, based on the collected information and product demand and price projections, dictates to second tier partners, prices, supply requirements, and other material terms, and accesses performance information of such second and third tier partners to monitor supply chain performance. While the above example assumes that performance information is supplied to the nearest downstream partner (or the party with whom the subject entity is in privity of contract), it is possible that one or more of the tier 1, 2, 3, and 4 partners and/or logistic providers provide performance information directly to the control tower services platform 150. It is further to be understood that any number of entities, factories, plants, or other facilities may exist at each of the brand, integration, device, and raw material levels.

Inventory can be tracked manually or automatically or a combination thereof. A manual system, for example, is a system known as the card system or cardex. Every time inventory is purchased or sold, the quantity is manually written on that item's card and a new on-hand amount totaled. Other manual systems use a type of manual entry system to record inventory transactions and record the entries in a spreadsheet program rather than on a paper card. In automated systems, whenever a movement of inventory occurs, an inventory management system receives an automatic update of the transaction. Various tracking methods exist to track inventory. The barcode, also known as the universal product code (UPC), remains one of the most common inventory tracking methods. Barcodes can track the movement of inventory throughout the supply chain. The barcode contains data on the item's description, the item's price and the item's unit of measure. Radio frequency identification (RFID) is another method used to track inventory. RFID technology comes in two forms: active RFID and passive RFID. Active RFID works best in environments where security issues exist and ones that require real-time tracking information. Passive RFID works best when used with handheld scanners and where security issues do not exist. Electronic Product Codes may also be employed. Code or identifier sensors or readers are positioned throughout the supply chain, typically at entrance and exit points to a facility, such as a warehouse, to detect inventory movement and identify what inventory items have moved. The readers at each ingress or egress (or choke) point can be meshed auto-ID or hand-held ID applications. Tracking can also be capable of providing monitoring data without binding to fixed location by using a cooperative tracking capability, e.g. a real-time locating system or RTLS. In this way, the inventory tracking system can track the addition of items to an inventory and any disbursements from inventory.

The detected codes or identifiers can be fed into Work in Progress models (WIP) or Warehouse Management Systems (WMS) or ERP software. These models or modules can then provide the inventory information to the other supply chain members, such as the control tower services platform 150.

“Performance information” typically includes any information relative to supply chain performance, including, without limitation, one or more of manufactured item output projections over a specified time period, production facility sizes and/or locations, raw material, work-in-process, and/or manufactured part, component, and/or product inventory levels, order cycle times, days of supply in inventory, manufacturing resource type, availability, reliability, and/or productivity (e.g., human and automated resource levels and resulting output levels), unit operations (e.g., manufacturing steps, functions, or operations, unloading raw materials, packaging parts, components, and/or products, loading parts, components, and/or products, and the like), financial factors (e.g., labor rates and costs, labor arbitrate, energy rates and costs, raw materials costs, freight costs, tax rates, administrative and overhead costs, contractual and/or current spot market part, component, and/or product prices (from lower tier components), and the like), number of on time shipments, number of late shipments, order mismatch count, service quality (e.g., repair returns, repeat repair, no fault found, etc.), repair cost per unit (e.g., material cost per unit, average repair time, pieces consumed per unit, etc.), inventory value (e.g., spare parts stock, SWAP stock, inventory turnover, days of supply of spare parts, days of supply of SWAP, days sales inventory spare parts, excess spare parts, excess SWAP stock, return to vendor rate, defective OHB, and return to vendor TAT, etc.), historic, current, and/or projected compliance with price, supply, and other customer requirements, and/or other material terms, compliance with regulatory, statutory, and other governmental requirements, historic, current, and/or projected parts, components, and/or product output levels, mean, median and/or average, mode, historic, and/or projected freight transportation times, delays, or requirements, and the like. The performance information can be associated with a date, month, and/or season-of-year. Metrics can be generated from the performance information, such as on time shipment rate or percentage, late shipment rate or percentage, product rejection rate based on nonconformance with one or more restrictions, specifications, and/or requirements, parts, components, and/or product acceptance rate based on conformance with one or more restrictions, specifications, and/or requirements, and the like.

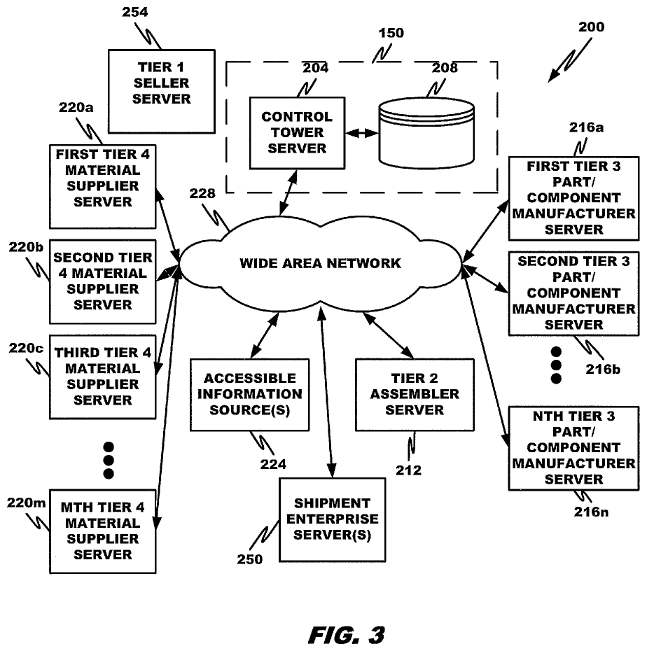

FIG. 3 depicts a communications networked architecture 200 according to an embodiment.

The control tower services platform 150 comprises a control tower server 204 and associated database management system (not shown) and database 208.

The control tower server 204 can be any computerized process that shares a resource with one or more client processes. It may run one or more services (typically as a host), to service the needs of other computers on the network. Typically, the control tower server 204 is a computer program running to serve the requests of other programs.

The database 208 can be any organized collection of data and their supporting data structures. The database can be based on any data model, including the relational model, entity-relationship model, object model, object relational model, XML, or other database model. The database 208 includes information related to any supply chain, logistics operation, enterprise and/or organizations in the supply chain and/or logistics operation (including information related to the physical infrastructure, engineering services, innovation services, and/or any other aspect of the physical infrastructure), raw materials, intermediate products, and/or end products (including specifications, formulations, designs, assembly methods and processes, cost and/or price information, and the like), in-process and product inventories, and the like.

The database 208 can include, for each enterprise and/or organization in the supply chain, not only performance information but also transactional documents (e.g., purchase order, material safety data sheets, bill of materials, supply and/or manufacturing agreements, RMAs, and the like), name, geographical location, geopolitical location, part and/or component and/or product and/or material type and/or identity supplied by the enterprise and/or organization, current spot market and/or contractual sales price of the part and/or component and/or product and/or material type supplied by the enterprise and/or organization, respective performance metrics of the enterprise and/or organization, part and/or component and/or product and/or material supply and/or purchase commitment with another enterprise and/or organization in the supply chain, specifications and requirements for part(s) and/or component(s) and/or product(s) and/or material(s) supplied and/or purchased by the enterprise and/or organization, part and/or component and/or product and/or material quantity and shipment dates and expected arrival dates at the next enterprise and/or organization in the supply chain, order cycle and/or turnaround times, shipment and/or order volume, total number of shipments, number of on time shipments, number of late shipments, order mismatch count, repair details, repair records (e.g., identity of purchaser, date of purchase, type of item returned, reason for return, repairs performed, etc.) for returned and/or warranty items, and each enterprise and/or organization is associated with one or more other enterprise and/or organizations in the supply chain to indicate a contractual or other supply relationship.

Role identifiers may be employed. Each enterprise and/or organization is normally assigned a role identifier, such as buyer, seller, supplier, manufacturer, material supplier, and the like, to describe the nature of the relationship of the enterprise and/or organization to each of the associated enterprise(s) and/or organization(s) in the supply chain. Each employee and/or consultant can be assigned one or more further role identifiers indicating a job title, hierarchical position within the enterprise and/or organization, work or project assignment, assigned work location, skill, expertise, and/or experience level within a defined subject matter, and a level of privilege to access information within the database 208.

Other types of tags can be employed. Tags can identify, for example, the type of data corresponding to the tag, permissions to access the corresponding data, summary of the content of the corresponding data, source of the data, and the like. Tags can identify spatial location (e.g., country code) of an object described by the corresponding data, culture of the object (e.g., European culture, Asian culture, etc.), and the like.

The data structures are typically time stamped with a time associated with an event described by the data, time of creation of the data structure, time of update of the data structure, and the like.

Referring again to FIG. 3, the tier 1 seller 100 has a corresponding server 254 to provide performance and other information, directly or indirectly, to the control tower server 204.

The tier 2 assembler has a corresponding server 212 to provide performance and other information, directly or indirectly, to the control tower server 204.

Each of the first, second, . . . nh tier 3 part/component manufacturers has a corresponding server 216a-n to provide performance and other information, directly or indirectly, to the control tower server 204.

Each of the first, second, third, . . . mth tier 4 material suppliers has a corresponding server 220a-m to provide performance and other information, directly or indirectly, to the control tower server 204.

The shipment enterprise and/or organization server 250 represents the freight enterprises or organizations handling shipments between nodes of the supply chain. The freight enterprises and organizations can be any entity providing shipping services. Exemplary freight enterprises and organizations include railway companies, short and long haul trucking companies, freight company servers (to provide freight tracking information, freight movement projections between two locations, and the like), shipping lines, maritime shipping companies, container shipping companies, Ro-ro shipping companies, transoceanic shipping companies, logistics services or courier companies, air freight carriers, and the like. The shipment enterprise and/or organization server 250 can provide to the control tower server 204 provide freight tracking information, freight movement projections between two locations, and the like.

The shipments can be tracked using an active and/or passive satellite positioning system, such as the Global Positioning System, that includes, in the vehicle, a receiver of position-based signals received from a satellite. A typical shipment tracking system, such as a vehicle tracking system, combines the use of automatic vehicle location in individual vehicles with software that collects the fleet data for a comprehensive picture of vehicle locations. Modern vehicle tracking systems commonly use GPS, GPRS, or GLONASS technology for locating the vehicle, but other types of automatic vehicle location technology can also be used. Vehicle information can be viewed on electronic maps via the Internet or specialized software.

The network accessible third party information source(s) 224 include any source of information relevant to supply chain and logistic tier members, raw materials, intermediate and end products and services, operations, and performance, including, without limitation, news sources and/or aggregators (to provide news on current events that may impact positively or negatively the supply chain performance, such as political coup d'etates, changes or upheavals, environmental conditions and events (e.g., storms, floods, earthquakes, tsunamis, typhoons, volcanic eruptions, forest fires, and other natural disasters, and the like), criminal acts (e.g., piracy, hijacking, theft, arson, vandalism, and the like), acts of violence (e.g., terrorism, war, political upheaval, military action, and the like), news reports on and announcements by a partner or competitor, scheduled events or holidays (e.g., religious, political, or other holidays), freight disruptions (e.g., train derailment, oceangoing vessel sinking, airplane crash, freight embargos, naval blockades, and the like), energy shortages, disruptions, or blackouts, and labor disruptions (e.g., strikes or threatened strikes)), weather data sources (e.g., the National Weather Service, national and local news sources, the Weather Channel™, Weather Source™, worldweatheronline.com, and the like), governmental entities (such as courts, law enforcement authorities, geological surveys, disaster relief agencies, and the like to provide legal or regulatory changes or requirements, lawsuits, bankruptcy filings, and the like, and other information), law enforcement or military authorities (e.g., to provide information on criminal acts (e.g., piracy, hijacking, theft, arson, vandalism, and the like), and acts of violence (e.g., terrorism, war, revolution, political upheaval, military action, and the like), competitor's products and supply chain operations and performance, time zone information, relative pricing structures between countries and/or parts thereof and/or for competitors for a selected supply chain tier and/or logistics services (e.g., labor arbitrage), and other information sources providing information relevant to the operations of the control tower services platform.

Such information sources can be monitored by many techniques, such as by word cloud techniques, which graphically represent word usage frequency. Generally, the more frequently a word or group of words is used the greater the likelihood that the fact or event described by the words or group of words exists. The words or group of words can further be weighted for reliability by the source, with law enforcement and military authorities being given a higher or more reliable weighting than news sources.

The various servers and sources are connected by a circuit and/or packet switched wide area network (“WAN”) that covers a broad area (e.g., any telecommunications network that links across metropolitan, regional, or national boundaries) using private and/or public network transports. An exemplary WAN is the Internet.

While the supply chain is described primarily with reference to manufacturing and distribution of a product, it can be applied equally to warranty and/or repair or maintenance services and logistics and procurement operations. The term “supply chain and logistics operation(s)” and variations thereof are intended to encompass these other types of operations.

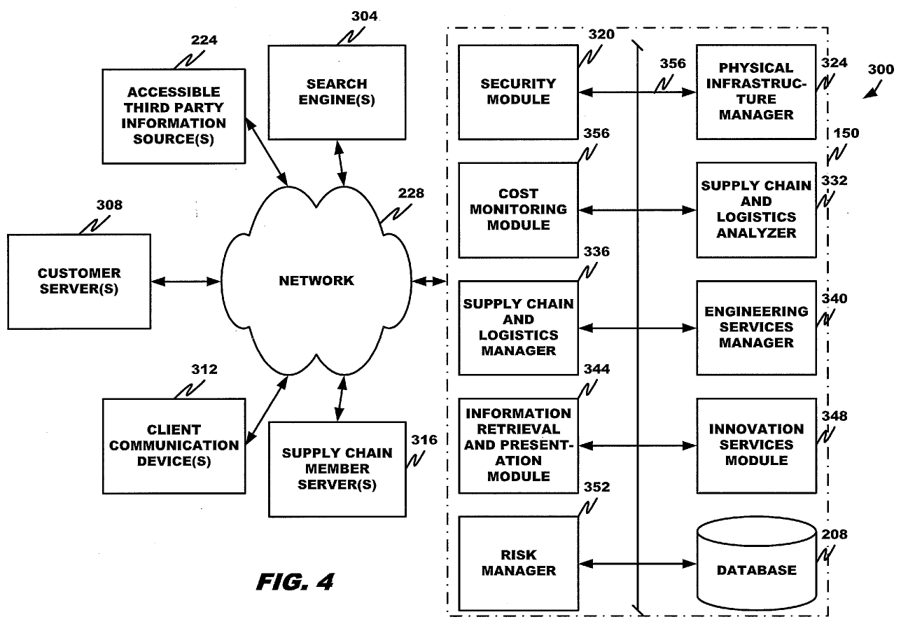

FIG. 4 depicts an example, of a supply chain monitoring system 300 including the control tower services platform 150 connected by wide area network 228 to search engines 304 (which can be any internet search engine), network accessible third party information sources 224, customer servers 308 (which typically refer to the tier 1 seller server 254 but may refer to a server of any supply chain customer), client communication device(s) 312, and supply chain member server(s) 316 (which generally includes the tier 1 seller server 254, tier 2 assembler server 212, the first, second, . . . nth tier 3 part/component manufacturer servers 216a-n, and the first, second, third, . . . mth tier 4 material supplier servers 220a-m). As will be appreciated, the control tower 150 can be maintained by any one of the tier 1, 2, 3, and/or 4 entities or an entity independent of the foregoing.

The control tower services platform 150 includes a security module 320, physical infrastructure manager 324, cost monitoring module 356, supply chain and logistics manager 336, supply chain and logistics analyzer 332, engineering services module 340, information retrieval and presentation module 344, innovation services module 348, risk supervisor 352, cost monitoring module 356, and database 208, all interconnected by trusted network 356 (such as a virtual private network or local area network within a demilitarized zone).

The control tower services platform 150 can monitor simultaneously multiple supply chain and/or logistics operation(s). The supply chain server(s) correspond to multiple different and independent supply chains. Each supply chain includes, with reference to FIG. 2, a tier 1 seller 100 and accompanying server 204, tier 2 assembler 104 and accompanying server 212, first, second, . . . nth tier 3 part/component manufacturer 108a-n and accompanying servers 216a-n, and first, second, third, . . . mth tier 4 material supplier 112a-m and accompanying servers 220a-m.

### The Security Module 320

The security module 320 enforces provisions and policies adopted by a network administrator to prevent and monitor unauthorized access, misuse, modification, or denial of the trusted network 356 and trusted network-accessible resources. Users can choose or be assigned an ID and password or other authenticating information that allows them access to information and programs within their authority. The security module 320 can include a firewall to enforce access policies such as what services are allowed to be accessed by the network users. Though effective to prevent unauthorized access, firewalls can fail to check potentially harmful content or malware, such as computer worms or Trojans, being transmitted over the network. The security module 320 can therefore include anti-virus software or an intrusion prevention system (IPS) to help detect and inhibit the action of such malware. The security module 320 can include an anomaly-based intrusion detection system to monitor and log the network and traffic for the trusted network for later analysis. The security module 320 can encrypt communications to maintain privacy.

Security challenges can be emphasized where the control tower services platform 150 monitors and manages multiple supply chains and logistic operations for different customers, which may be competitors in one or more market segments. This can be done using a number of techniques.

The security module 320 can enforce access privileges and maintaining data integrity for each enterprise, organization, and supply chain.

The security module 320 can use an application-based technique by determining whether the user has permission to access one or more of the physical infrastructure manager 324, control tower server 204, supply chain and logistics manager 336, supply chain and logistics analyzer 332, engineering services module 340, information retrieval and presentation module 344, innovation services module 348, risk supervisor 352, database 208, and/or trusted network 356. This can be determined using licensing techniques, whereby the user is subjected to access and/or feature restrictions depending on payments made to the platform operator.

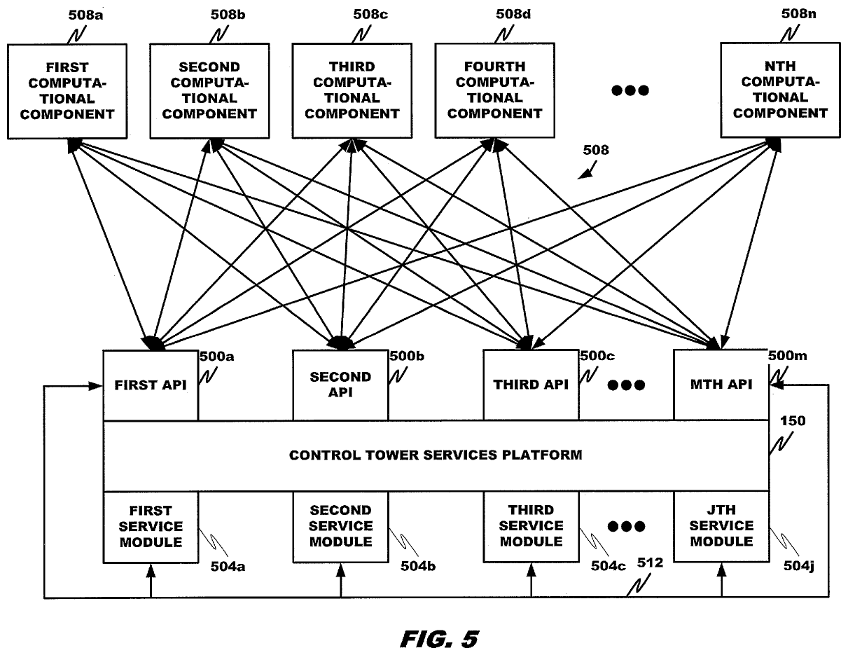

The security module 320 can use an application programming interface (“API”)-based technique, which determines whether the user has permission to access one or more of the APIs. This approach will be discussed with reference to FIG. 5. With reference to FIG. 5, The first, second, third, . . . mth API(s) 500a-m define or specify how software components interact with one another. The software components include the first, second, third, . . . jth service modules 504a-j (which include the physical infrastructure manager 324, control tower server 204, supply chain and logistics manager 336, supply chain and logistics analyzer 332, engineering services module 340, information retrieval and presentation module 344, innovation services module 348, risk supervisor 352, and database 208), and the first, second, third, fourth, . . . nth computational components 508a-n (which can include the client communication device(s) 312, customer server(s) 308, supply chain member server(s) 316, computational components associated with the enterprise operating the control tower services platform 150, and applications executing on any of the foregoing.

Typically, each API 500 is a library that includes specification for routines, data structures, object classes, and variables. The API 500 may be implemented in a procedural language or object-oriented language. An API 500 specification can take many forms, including an International Standard such as POSIX, vendor documentation such as the Microsoft Windows™ API and/or the libraries of a programming language, e.g., Standard Template Library in C++ or Java API. An API differs from an application binary interface (ABI) in that an API 500 is source code based while an ABI is a binary interface. As shown by the external and internal communication links 508 and 512, respectively, all internal and external signaling, including inter-application, intra-application, and/or inter-device messages, pass through the any of the first, second, third, . . . and mth APIs 500a-m.

Although the user may be licensed to use an application, he or she may not be licensed or privileged to use one or more APIs 500 within and/or servicing that application. Permission can be determined using licensing techniques, whereby the user is subjected to access and/or feature restrictions depending on payments made to the platform operator, or enforcement of privileges. The query, command, and/or request is typically further required to conform to the requirements of the API and, when the query, command, and/or request fails to conform to the requirements of the API, the security module 320 can deny the query, command, and/or request even though the requestor has permission to use the API 500. The use of APIs can enable third party applications to be readily interfaced with the platform 150.

The security module 320 can also enforce data entity or role-based restrictions, whereby specified roles can create, read, update, and delete specified objects. For example, a platform 150 administrator role can create, read, update and delete enterprise and/or organization, administrator, organization, site, item, and user objects. An administrator for an enterprise and/or organization in a particular supply chain, by contrast, can create, read, update, and delete administrators, users, organizations, sites, and items but only for the particular enterprise and organization. An event manager for an enterprise and/or organization can create site, item, item-site relationships, item-item relationships, and supply chain events but only for the particular enterprise and organization. Other roles include in house counsel, corporate officer, board member, manager, project manager, supervisor, engineer, designer, clerical staff, associated enterprise or organization identifier, and the like. Generally, each potential user will have multiple role-based tags, including an identifier of the enterprise or organization associated with the user, an identifier of a role of the enterprise or organization in the supply chain or logistics operations, and an identifier of a role of the user within the associated enterprise or organization.

The security module 320 can enforce field level-based restrictions, which determine whether or not the user has permission to view or change the field. This technique can also be role-based and use the roles or tags identified above.

In either of the data entity or field level-based techniques, data objects can have different states (e.g., a purchase order can have different states) and be viewed as state machines, whereby a state of a data object is changed by an action. Stated another way, actions cause transitions between states. Each state has a collection of actions that are allowed and permissions associated with performing an action. States can have sub-states for a particular role type. For example, a tier 1 seller may have a requirement to approve a sell price by a manager of the tier 1 seller before committing the order. Basically, all actions can update an artifact except the first one (create). When an update or delete request is received, the security module 320 or API checks the permissions for the state. When permitted, the update is executed and the artifact assigned a next state or deleted.

Yet another technique is to control the structure of, or restructure, database queries, commands or requests to comply with relevant sets of permissions. A requestor can write any database query, command, or request desired. The security module 320 receives and applies a security definition to the query, command, or request. If required, the security module 320 edits the query, command, or request consistent with the security definition. The revised or restructured query, command, or request is then passed onto the API of the data collection and maintenance module. By way of example, assume that there are two supply chains, with the tier 1 control tower on one supply chain being associated with Hewlett Packard™ laptops and the tier 1 control tower on the other supply chain being associated with Dell™ laptops. They each share a common tier 3 component manufacturer, namely Intel™, which supplies integrated circuit boards to each supply chain. A Dell employee provides the following query to the platform 800:

Q: Select*from order where Seller=*and Buyer=*, where “*” is a wildcard.

This query, if executed, would provide the Dell™ employee with all rows and fields in both the Hewlett Packard™ and Dell™ supply chains. To provide the Dell employee with the supply chain information to which he or she is entitled, the security module can restructure the query as follows:

Q: Select*from order where Seller=Dell or Buyer=Dell.

This query provides the requestor with only rows and fields in which Dell is either seller or buyer. Because Intel™ is common to both supply chains, the following query “Q: Select* from order where Seller=Intel or Buyer=Intel will retrieve rows and fields from both supply chains in which Intel is either seller or buyer. In this manner, the security module 320 can implement both row-based and field-based access restrictions, in a readily scalable format, without requiring users associated with enterprises and organizations in the supply chain to voluntarily restrict database queries, commands, and requests in accordance with a particular grammar or language.

While the security module 320 is discussed with reference to information involving only a particular enterprise or organization, it is to be understood that the enterprises and organizations within a supply chain and/or logistics operations can agree to provide information to other enterprises and organizations located upstream of downstream in the supply chain, such as to the tier 1 seller. In such cases, the security definition takes such expanded information access into consideration.

The security module 320 can enable the collected information to be maintained in one data location (and common database) without the use of a partitioned database. In other words, the database is not partitioned logically (horizontally or vertically) into distinct and independent parts corresponding to different monitored supply chains, and the data and/or data structures for different monitored supply chains and/or logistics operations can be commingled and/or conform to a common data model in the database. This can enable the use of a simpler data model that enables ease of constructing relationships between enterprises and organizations, provide stability, and provide scalability. Each data row of the model can have a different schema. The data model can also enable sharing of information across and among different supply chains.

### The Physical Infrastructure Manager 324

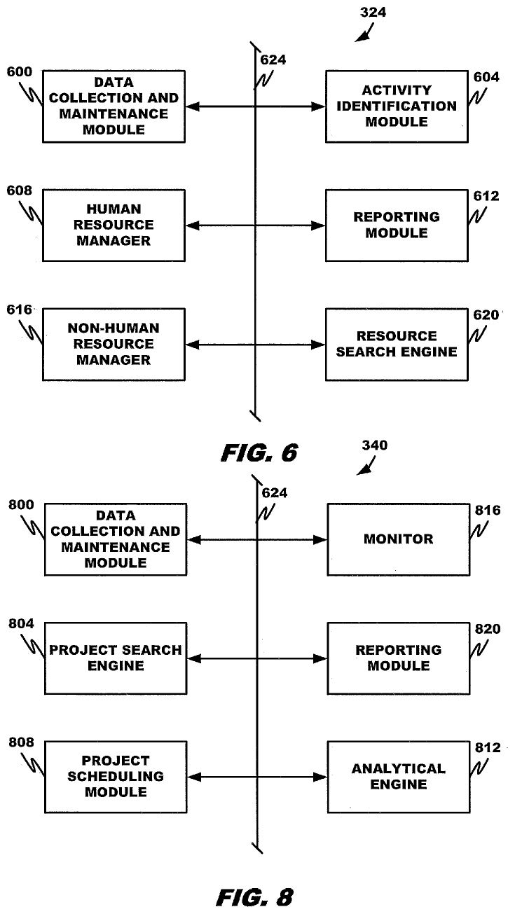

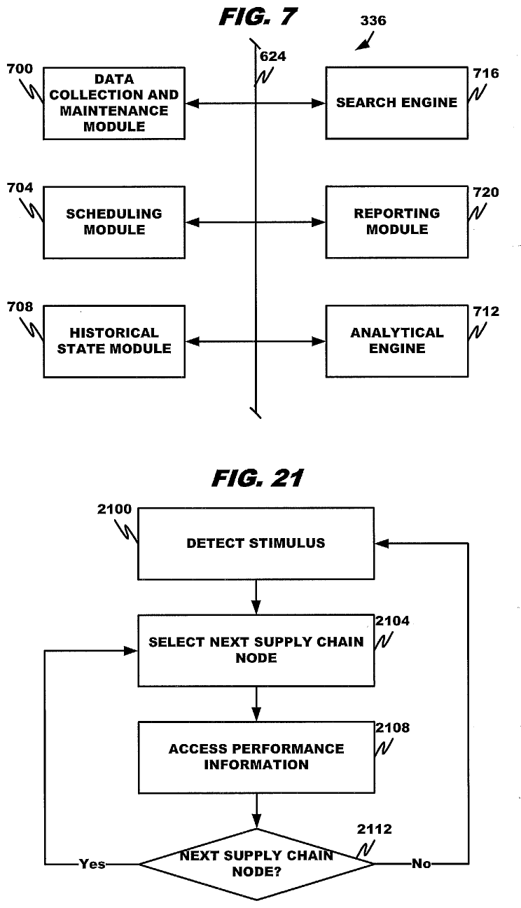

The physical infrastructure manager manages physical resources, such as physical plant and equipment (e.g., manufacturing sites (e.g., plant and equipment), warehouses, inventory, office buildings and equipment, and other tangible assets) and employees, consultants, and contractors, which are located in various different countries and global in scale. The modules of the physical infrastructure manager 324 are shown in FIG. 6.

The manager 324 includes a data collection and maintenance module 600, an activity identification module 604, human resource manager 608, reporting module 612, non-human resource manager 616, and resource search engine 620, connected by a local area network or bus 624.

The data collection and maintenance module 600 collects data and maintains data structures in the database 208 regarding tangible and intangible resources. The data collection and maintenance module 600 can include a database management function that stores, updates and otherwise manages the data in the database 208 in accordance with a selected data model.

The data can be collected from various sources. Examples include enterprise databases recording physical assets, personnel records, an inventory tracking system, a real-time locating system for inanimate and animate objects, a fleet management and location system, information management systems, management information systems, enterprise resource planning systems, customer relationship management systems, knowledge management systems, enterprise information system, and the like.

The data structures are typically associated with one or more enterprises and/or organizations in the supply chain. Data includes, for example, documentation and other information regarding tangible resources, such as employment and consulting contracts, supply agreements, purchase agreements, equipment leases, employee and consultant evaluations, skills, experience, work history, ratings, position or role within the associated organization, and assigned work location, regulatory and statutory restrictions and requirements relating to tangible resources, scheduling information (such as employee Outlook™ calendars and manufacturing and logistics schedules), enterprise or organization policies and rules, financial information (e.g., sales revenue, tax rates, and capital, overhead and operating costs, labor costs, raw material costs, etc.), facilities descriptions including on site equipment, and square footage, and the like. The data structures can provide visibility into historic and current activities of the resource described by the data structures.

Tags may be appended to data structures to enhance searching. The tags can be describe an associated physical resource and/or summarize a corresponding field of an associated physical resource description. Tags, for example, can indicate a role of an employee or consultant, a type of facility, a type of operation performed at a facility, a risk factor associated with a facility, a performance score associated with a resource, a location score associated with a resource, a geo-political score associated with a resource, a degree of availability or unavailability of a resource, a skill, experience, and/or performance rating of a resource, and the like.

The activity identification module 604 identifies historical and current activities or states of each physical resource. For example, the activity identification module 604 identifies current work assignments of each employee and consultant and current operations related to a selected supply chain and/or logistics operation being performed at each facility and/or by each service provider in the supply chain and logistics infrastructure. This information is provided to the data collection and maintenance module 600 for inclusion in the database 208. The information enables a degree of availability or unavailability to be determined for each physical resource. This information can be used in utilizing fully the resources.

The human resource manager 608 determines how human physical resources are currently being used and confirms that the resources are being employed and described properly (e.g., in compliance with CSER, regulatory and statutory requirements and restrictions, and corporate rules and policies), effectively (e.g., being used as designed and intended), and efficiently (e.g., being used at or near design capacity) and provides services to employees and consultants to address cultural differences, different regulatory and statutory requirements and restrictions at each facility, language differences, time zone differences, CSER, and other obstacles and hindrances to employee and consultant interactions and confirm that employees and consultants are trained, assigned, and described properly. The human resource manager 608, for instance, can provide cultural descriptions (e.g., acceptable and unacceptable behavior in each culture) to coach employees and consultants on how to work together, descriptions of regulatory and statutory requirements and restrictions at each facility, automated translators to enable communications to be converted readily between languages, descriptions of enterprise or organizational rules and policies applicable to each physical resource or interaction between resources, e-mail and social networking capabilities similar to Linkedin™ to enable employees and consultants to interact effectively, harmonizes employee and consultant training in all cultures to ensure all like employees and consultants receive similar training, determines and tracks, hierarchically, employee and consultant positions in the organization, and confirms, based on input from the activity identification module, that each employee and consultant is, based on historically and currently performed work assignments, properly described in terms of his or her skills and experience and/or engaged currently in appropriate activities for his or her skills and experience, job title, and hierarchical position in the organization.

The non-human resource manager 616 determines how non-human physical resources are currently configured and used and confirms that the resources are being employed and described properly (e.g., in compliance with CSER, regulatory and statutory requirements and restrictions, and corporate rules and policies), effectively (e.g., being used as designed and intended), and efficiently (e.g., being used at or near design capacity).

The resource search engine 620 receives, from the reporting module 612, a search query about an identified human and/or non-human resource and/or need for an unidentified human and/or non-human resource and provides a suitable response to the reporting module 612. An example would be a query directed to a specific employee or consultant or group of employees or consultants or physical facility or equipment to determine a current work assignment, operation, and/or degree of availability or unavailability of same. Another example would be a query directed to a described need for a human or non-human resource, such as skill set or experience level desired for a specific project or task, a facility or item of equipment required for a specific project or task, etc.

The reporting module 612 receives queries from authorized requestors, collects the information (such as from one or more of the other components of the physical infrastructure manager), and provides the information to the information retrieval and presentation module for presentation to the requestor.

### The Control Tower Server 204

The control tower server 204 is a computational system handling requests received over the network 228 to provide, or assist in providing, a service, such as a service provided by any of the first, second, third, . . . jth service modules 504a-j. While the computer infrastructure is described with reference to a client-server architecture, it is equally applicable to a peer-to-peer architecture.

### The Supply Chain and Logistics Manager 336

The supply chain and logistics manager 336 can collect and store supply chain and/or logistics operation performance information, verify accuracy of scheduled delivery times, provide estimates of delivery times, identify potential manufacturing and delivery problems, and identify and quantify the effects of expected and unexpected events on supply chain and/or logistics performance. The supply chain and logistics manager 336 includes a data collection and maintenance module 700, a scheduling module 704, a historical state module 708, an analytical engine 712, a search engine 716, and a reporting module 720, connected by a local area network or bus 624.

The data collection and maintenance module 700 collects performance information from tier 1, 2, 3, and/or 4 entities and freight companies (or logistics operations) in the supply chain and/or logistics operation(s) and from accessible information source(s) 224 as noted previously in connection with the control tower. The data collection and maintenance module 700 can parse the collected information, extract relevant information items, and optionally tag the extracted information items with an information type tag. The data collection and maintenance module 700 can include a database management function that stores, updates and otherwise manages the data in the database 208 in accordance with a selected data model.

The data collection and maintenance module 700 can provide end-to-end supply chain visibility of the supply chain. The data collection and maintenance module 700 may include aggregation of supply chain snapshot data and supply chain flow data to provide improved end-to-end supply chain visibility. Further information is provided by copending US Published Application No. 2013/0080200, which is incorporated herein by this reference.

The data structures are typically associated with one or more enterprises and/or organizations in the supply chain and/or logistics operation(s). Transactional documents, such as purchase orders, material safety data sheets, and bills of material, contain references to all owners down the organization level, have corresponding role types and functions specified (e.g., only a buyerRole can change requestQuantity field) , and include preferences and settings referenced to an appropriate level (e.g., enterprise, organization (or the part of the enterprise involved in the supply chain and/or logistics operation(s) transaction), user, etc.).

Events stored and maintained in the database 208 by the data collection and maintenance module 700 typically include event category, event type, event subtype and event severity tags. Event categories include, for example, material and/or component shortages, natural disaster (e.g., natural disaster event and wherein the natural disaster is one or more of an earthquake, tsunami, volcanic eruption, fire, flood, avalanche, and landslide), weather (e.g., storm, typhoon, hurricane, cyclone, tornado, wind,and blizzard), political (e.g., coup d'etate, sabotage, terrorism, act of war, military action, police action, embargo, and blockade), and business (e.g., a maritime vessel sinking, train derailment, freight vehicle wreck, device or system malfunction, criminal activity, airplane crash, labor disruption, lawsuit, financial insolvency, bankruptcy, and stock or financial market corrections or downturns). Event types include, for example, geologic event, atmospheric event, geo-political, labor, and insolvency. Event subtypes include, for geologic, earthquake, volcanic eruption, tsunami, flood, and landslide; for atmospheric, storm, hurricane, cyclone, tornado, wind, and blizzard; for geo-political coup d'etates, sabotage, terrorism, and piracy; for labor, strike; and for insolvency, bankruptcy. The severity tag can include one or more of emergency, advisory, watch, and warning. Other tags will be obvious to those of ordinary skill in the art based on the teachings of this disclosure. A start and end time can be associated with the temporal impact of the event on the supply chain and/or logistics operation(s).

The collected information generally falls into two categories, namely static supply chain and/or logistics operation(s) information (information items that generally do not change or change infrequently such as sites, enterprise and/or organization names, and the like) and dynamic supply chain and/or logistics operation(s) data (information items that change frequently such as purchase orders, forecasts, and the like).

The scheduling module 704 provides scheduling information, including projected shipment arrival dates at the tier 1 seller for products from the tier 2 product assembler 104 and required shipment departure dates for branded products to customers, wholesalers, and/or retailers. Each of the shipment arrival and departure dates can be linked to a set of data structures describing the shipment, including shipment source and destination, freight carrier, freight tracking information, current shipment status, shipment contents (by product type and number), date of shipment, and the like). The projected shipment arrival dates at the tier 1 seller can be received from the tier 2 product assembler 104 and/or freight carrier. The shipment departure dates are determined by the tier 1 control tower based on contractual requirements, retailer and/or wholesaler current or projected inventory levels, retainer and/or wholesaler order, and the like.

The historical state module 708 tracks past performance for each entity and/or entity facility in the tier 1-4 and freight carriers (e.g., compares the actual product shipment arrival date against a selected date (received from the entity, required by contract or order, and/or projected by the control tower services platform 150)) and distribution chain demands (to identity seasonal trends). The past performance for an entity can be used to determine and assign a level of confidence in product deliveries from the entity being received by a selected date (received from the entity, required by contract or order, and/or projected by the tier 1 seller 100). The level of confidence, when low, may provide a basis to order additional product from a more reliable source. The level of confidence can be based on past performance of each supplier or each different facility of a common supplier.

The analytical engine 712 receives performance and other data from the data collection and maintenance module 700, scheduling information from the scheduling module 704, and historical information (such as a level of confidence) from the historical state module 708 and, based on the information, forecasts incoming shipment arrival times and outgoing shipment departure times and identifies any inability to meet distribution chain requirements, commitments or objectives (e.g., orders, contractual commitments, policies, objectives, etc.) (a “noncompliant event”). This information is provided, by the analytical engine 712 to the risk manager 716. The analytical engine 712 can be a type of situational awareness application that looks at aspects of the current state of the supply chain and/or logistics operation(s) as well as the structural relationships and considers the effect of both internal and external events on the supply chain and/or logistics operation(s). Both past events and forecasted events can be considered by the analytical engine 712. The application can determine not only what happened to the supply chain and/or logistics operation(s) but also what may happen to the supply chain and/or logistics operation(s), thereby providing not only a reactive but also proactive model for problem resolution.

In one application, the analytical engine 712 relies primarily on reported performance information received from tier 1 seller 100, tier 2 assembler(s) 212, tier 3 component manufacturer(s), tier 4 raw material supplier(s) and/or freight carrier(s) in estimating compliance with product distribution chain requirements. Disruptive events received from an accessible information source 224 are used as the basis of a query to the potentially impacted tier 2 assembler(s) 212, tier 3 part/component manufacturer(s), tier 4 material supplier(s) and/or freight carrier(s) for updated performance information. The query may be generated automatically or manually by tier 1 management.

In one application, the analytical engine 712 determines, based on performance information received from the historical state module 708, a performance rating for each enterprise and/or organization in the supply chain and/or logistics operation(s). The performance rating can be based on a scale from lowest performance level to highest performance level.

In one application, the analytical engine 712 relies not only on reported performance information but also internally generated projections in estimating compliance with distribution chain requirements. The compliance determination is based on one or more comparisons, including a comparison of the material and/or part and/or component and/or product shipment delivery date based on the reported performance information against the material and/or part and/or component and/or product distribution chain shipment requirement(s) (as in the prior paragraph), a comparison of the material and/or part and/or component and/or product shipment delivery date based on the reported performance information against the internally generated projected material and/or part and/or component and/or product shipment delivery date, and a comparison of the material and/or part and/or component and/or product shipment delivery date based on the reported performance information against the internally generated projected material and/or part and/or component and/or product shipment delivery date.

The estimated or projected delivery date for an order can include an associated probability or likelihood and, optionally, an associated range of arrival dates that the items in the order will be timely received by the selected arrival date or within the range of arrival dates. The range of arrival dates can be selected using a standard deviation of arrival times based on current and/or historic performance information and/or other relevant information. For example, a historic reliability or probability of timely receipt at a destination facility from the selected lower tier facility, and optionally associated standard deviation of historic receipt dates relative to a target date, can be used to provide the probability and optionally standard deviation of the destination facility receiving a current shipment from the selected lower tier facility. The probability and/or standard deviation can be used by the risk manager to determine whether or not to order additional material and/or part and/or component and/or product from an alternate facility. This determination can use a probability threshold, for instance, that would require or recommend order placement to an alternative facility if the probability of the order timely arriving is too low or no order placement to the alternative facility if the probability of the order timely arriving is acceptable (e.g., exceeds the probability threshold).

For any facility in a tier, the probability could be the sum or other mathematical combination of probabilities for each upstream facility in lower tiers in a direct or indirect supply relationship with a selected facility. For example, if a third part/component manufacturing facility in tier 3 has a 50% probability of receiving timely raw material from a fourth and/or alternative facility in tier 4, a second product manufacturing facility or assembler in tier 2 has a 50% probability of receiving timely a necessary product part and/or component from the third facility and/or an alternative tier 3 facility, and the first facility in tier 1 seller has a 25% probability of receiving the product timely. When a selected facility, such as a product assembler, has a 50% probability of receiving timely a first necessary component from a first tier 3 part/component manufacturer and a 25% probability of receiving timely a second necessary component from a second tier 3 part/component manufacturer, the probability of a third tier 1 facility receiving the product timely from the selected product manufacturing or assembling facility is the lower of the two or 25%.

A number of algorithms may be used by the analytical engine 712 in generating the internal estimates. Examples include one or more of a critical path method (“CPM”) (which is an algorithm for scheduling a set of project activities), queueing theory (which characterizes the supply chain and/or logistics operation(s) as one or more queues of work pieces being “serviced” at each tier and thereby defining supply chain and/or logistics operation(s) behavior based on queue behavior), a scheduling algorithm (which considers product production scheduling and shipping and includes forward and/or backward scheduling), and/or simulation modeling using discrete or continuous simulations.

The analytical engine 712 can use pattern or template matching to determine internal estimates. The patterns or templates can be based on historical data patterns and observed shipment times and/or on patterns or templates predetermined or predefined by system administrators. The analytical engine 712 can search by one or more of the time, location and setting. For example, for an earthquake in Asia having a specified severity level, the analytical engine 712 can search for other earthquake events in Asia over the last three years having a similar severity level and determine the actual shipment times and/or administrator shipping estimates or projections made for the currently selected or other supply chain and/or logistics operation(s) to determine a current estimate or projection.

The analytical engine 712 can detect unreported events by identifying unexpected variations in collected performance information. For example, where one or more selected nodes of the supply chain and/or logistics operation(s) experience a sudden drop in rate of on-time shipments or rise in rate of late shipments and the drop is sustained over a selected period, the analytical engine 712 can deduce that a disruptive event has occurred. The possibility of an occurrence of an unreported disruptive event can be reported to a system or supply chain and/or logistics operation(s) enterprise and/or organization administrator. Likewise, the severity of an event and/or shipment projections can be changed and rendered more accurate by observing actual behavior following creation of the event or estimate or projection. This information can also be used to refine temporally proximate estimates or proj ections.

The analytical engine 712 can also calculate and update performance measures as information is collected by the data collection and maintenance module 700. In other words, the calculation and updating of performance measures is done substantially in real time. Alternatively, the analytical engine 712 can calculate the performance measures when and as requested by a user. In other words, the performance measures are not precalculated. This can obviate the need for an analytics database altogether.

The analytical engine 712 can analyze supply chain snapshot data and supply chain flow data and modify the supply chain snapshot data based on the supply chain flow data. The supply chain snapshot data may include asynchronous supply chain snapshot data from multiple supply chain members. The asynchronous snapshot data has different time stamps. The asynchronous supply chain snapshot data may include an inconsistency based on a change in a supply chain status of a supply chain member during the time stamps of the asynchronous snapshot data. The supply chain flow data may be indicative of the inconsistency, and the inconsistency may be removed from the validated supply chain data at least partially based on the supply chain flow data.

The analytical engine 712 can perform a business process flow based on the validated supply chain status data. The business process flow may include a forecast collaboration process, an order management process, a data quality process, an inventory management process, an excess and obsolescence monitoring process, or an inventory redistribution process. Accordingly, in response to the business process flow, the analytical engine 712 may communicate business process flow data to the data collection and maintenance module. The data collection and maintenance module may communicate the business process flow data to supply chain member.

The analytical engine 712 calculate a key performance indicator (KPI) based on the validated supply chain data indicative of the performance of the supply chain member relative to a predetermined supply chain management plan. Accordingly, the analytical engine 712 may include a dashboard, in which the KPI is graphically displayed by the reporting module to the user.

The supply chain snapshot data may include material requirement planning (MRP) data. Additionally, the supply chain flow data may correspond to inter-site data exchanged between supply chain members. The supply chain flow data may comprise electronic data interchange (EDI) messages. The supply chain flow data may correspond to flow data in other appropriate formats such as, for example, alternative formats of system-to-system messaging, spreadsheets, email messages, phone calls, etc. The analysis of the supply chain snapshot data and the supply chain flow data may be performed autonomously. Further details of the analysis of supply chain snapshot data is provided in copending U.S. application Ser. No. 13/630,153, filed Sep. 28, 2012, which is incorporated herein by this reference.

The search engine 716 receives search queries from a requestor, which may be edited by the security module, and retrieves the supply chain and/or logistics operation(s) information from the database 208 and provides the information to the reporting module 720.

The reporting module 720 provides the reporting information to the information retrieval and presentation module 344 for provision to one or more of a customer server 308, supply chain member 316, and/or client communication device 312.

The reporting module 720 can not only provide reports containing performance information but also generate map displays.

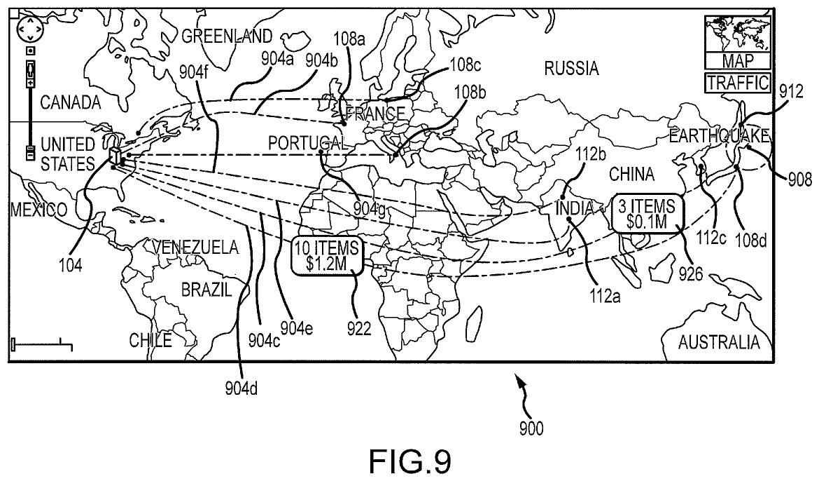

FIGS. 9-15 are a series of screen shots demonstrating reporting information provided by the reporting module 720.

With reference to FIG. 9, the display 900 shows locations of various supply chain and/or logistics operation(s) nodes, including the tier 2 product assembler 104, first, second, third and fourth tier 3 part/component manufacturers 108a-d, and first, second, and third tier 4 material suppliers 112a-c. Material and/or part and/or component and/or product shipment lines 904a-g between the various related nodes can be shown. Different colors or shades of a common color can be assigned to each shipment line to indicate on-time shipments, slightly delayed shipments, moderately delayed shipments, and heavily delayed shipments. A disruptive event, such as a weather event, earthquake event, business disruption event, geo-political event, and financial disruption event, can be shown on the map at a location 908 impacted by the event. A range of disruption 912 is also assigned to the event indicating a likely spatial range impacted by the event. As will be appreciated, different event types and events for a given event type can have differing assigned spatial ranges of disruption. For example, an earthquake may have a larger spatial range of disruption than a storm, and an 8.0 earthquake on the Richter scale would have a larger spatial range of disruption than a 5.5 earthquake on the Richter scale. A range can be modeled by many techniques, such as by using a shape file. Additionally, moving a cursor over a node, shipment line, or event can cause a box or icon, such as shown by boxes 922 and 926, to appear providing relevant information about the associated one of the node, shipment line, or event. For example, relevant information about the node can include enterprise and/or organization name, materials and/or part and/or component and/or products supplied by the enterprise and/or organization, and one-hop related enterprises and/or organizations (e.g., the supplier to the selected node and the purchaser from the selected node). Relevant information about the shipment line can include the name of the freight carrier, number, type, and value of material and/or part and/or component and/or product currently being shipped, and the current status of the shipment. Relevant information for the event can include the event category, type and subtype and severity, number of materials and/or part and/or component and/or products impacted, number of downstream parts and/or components and/or products impacted (such as the parts and/or products supplied to the tier 2 product assembler 104), potential financial impact on the tier 1 control tower 100, and number of supply chain and/or logistics operation(s) sites affected. The boxes in FIG. 9 show relevant shipment information including a number and value of products, parts, and/or components currently en route along the corresponding shipment line.

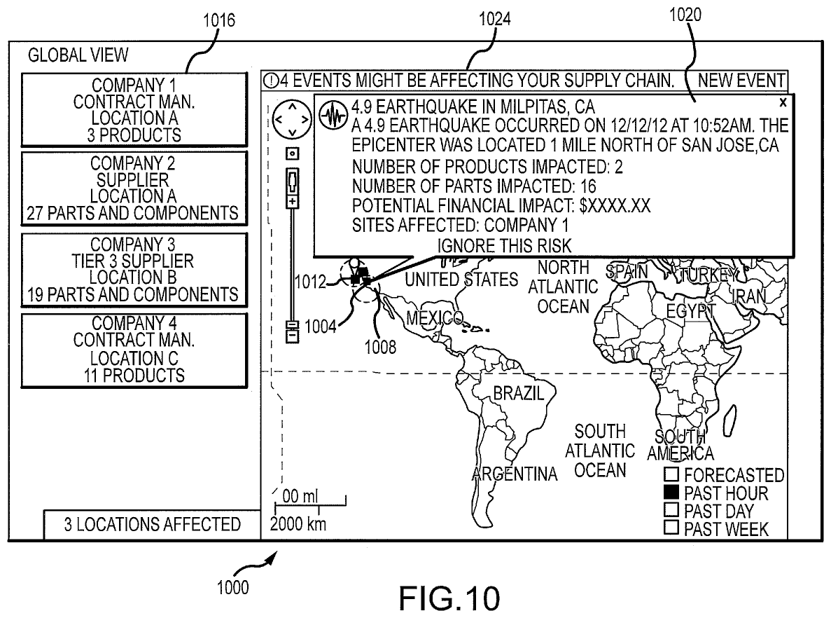

With reference to FIG. 10, the reporting module provides a display 1000 showing a location 1004 and impacted range 1008 of an event (a 4.9 earthquake) and locations 1012 and descriptions 1016 of various enterprises and/or organizations in the supply chain and/or logistics operation(s), namely companies 1-4 with relevant information provided about each enterprise and/or organization (e.g., role, location, and products, parts, and/or components provided to the supply chain and/or logistics operation(s)). By moving the cursor over the location of the event, a box 1020 appears providing event information, including a description and location of the event, number of products impacted by the event, number of parts impacted by the event, potential financial impact of the event, and supply chain and/or logistics operation(s) sites affected by the event. A message 1024 is also provided at the upper part of the display 1000 indicating a number of events (e.g., 4) potentially impacting the supply chain and/or logistics operation(s) at the present time.

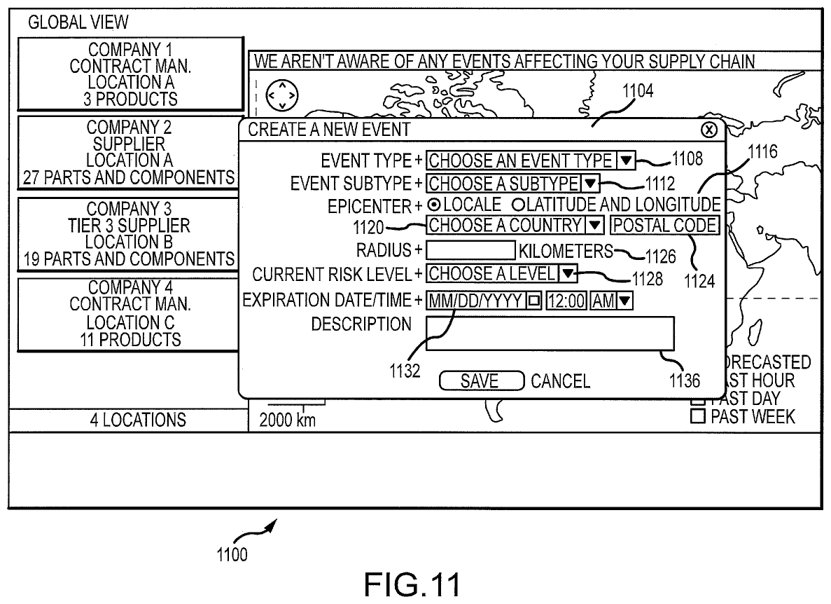

With reference to FIG. 11, the reporting module provides a display 1100 showing an administrator input box 1104 to provide event information to the data collection and maintenance module. The input box 1104 includes fields for event type 1108, event subtype 1112, event epicenter 1116 (which lets the administrator elect whether to have the data collection and maintenance module locate the epicenter or provide latitude and longitude of the epicenter), country of epicenter location 1120, postal code of epicenter location 1124, radius impacted by the event 1126, current risk (or severity) level 1128, event expiration date and time 1132, and event description 1136.

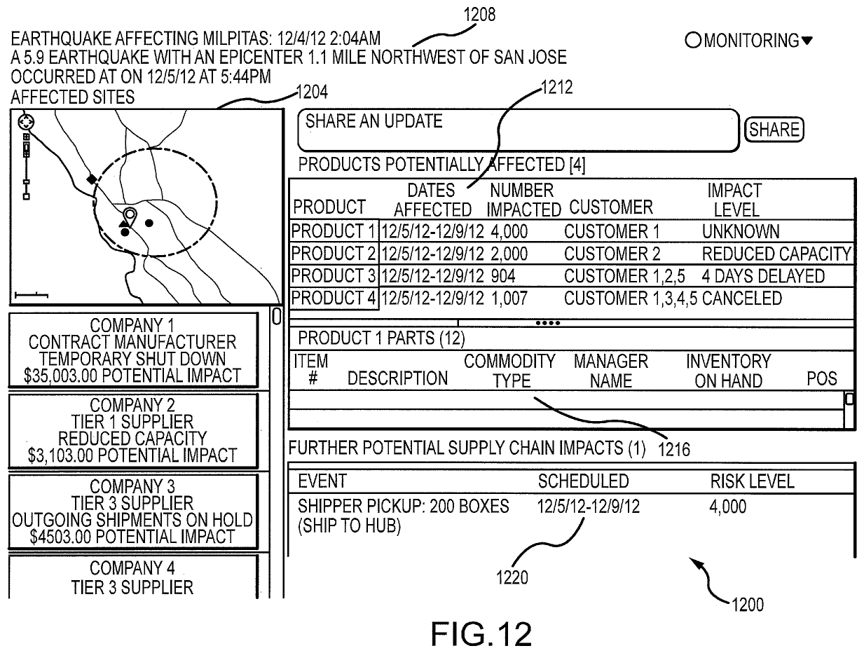

With reference to FIG. 12, the reporting module provides a display 1200 providing information about the impact of a selected event on the supply chain and/or logistics operation(s). The display 1200 includes a picture 1204 showing the epicenter and impact radius of the event and supply chain and/or logistics operation(s) sites affected within the impact radius, a description of the event 1208, products potentially affected by the event 1212, parts and/or components potentially affected by the event 1216, and other potential supply chain and/or logistics operation(s) impacts 1220.

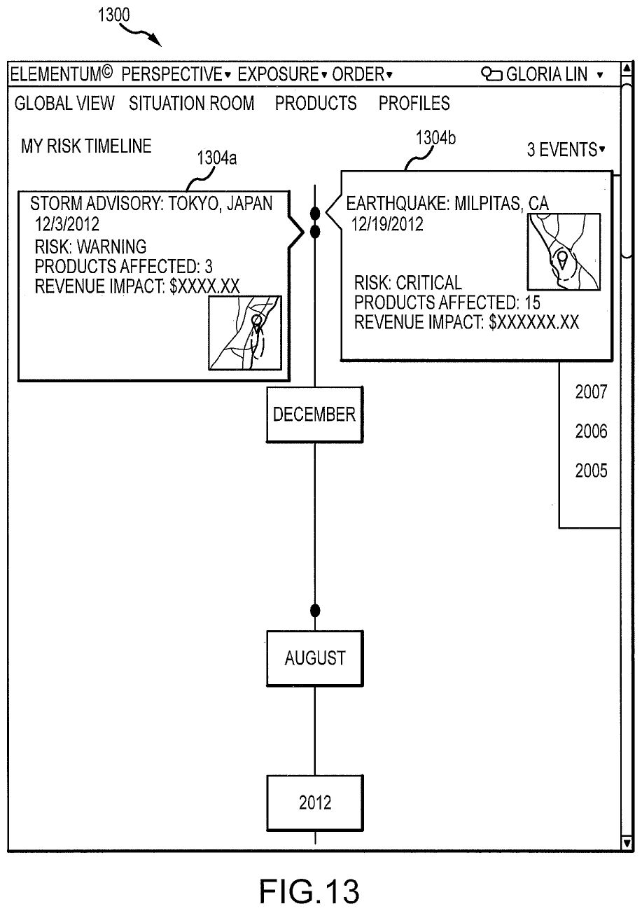

With reference to FIG. 13, the reporting module provides a display 1300 showing events occurring over a selected time period. Each event description 1304 shows event type, event date, event severity, number of products, parts, or components affected, and revenue impact on the selected enterprise and/or organization.

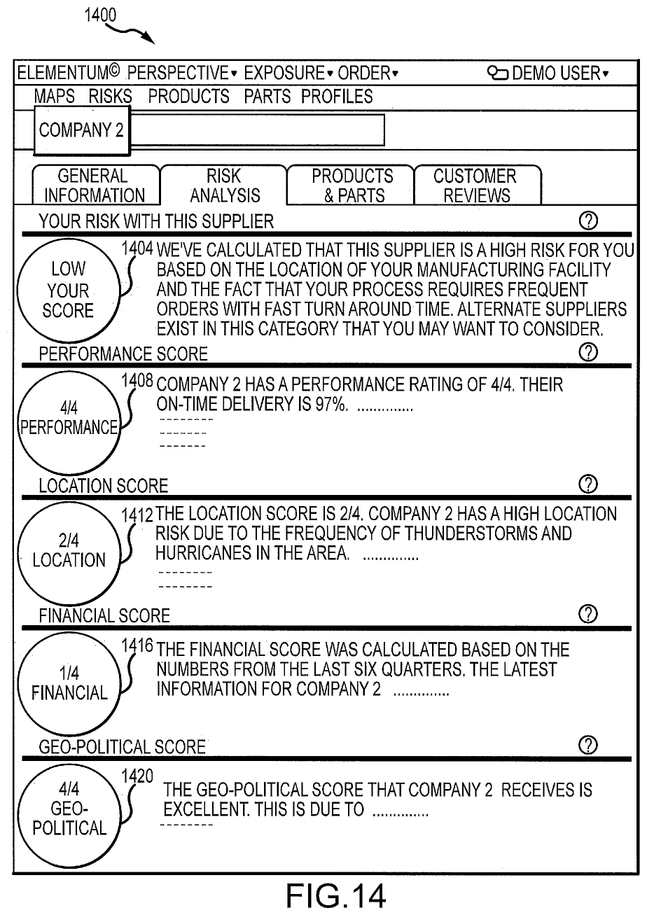

With reference to FIG. 14, the reporting module provides a display 1400 showing a product, part, or component supplier description for a selected company (e.g., enterprise or organization). The description includes a supplier risk category 1404 (e.g., low, moderate, and high) and the various factors used in developing the risk category. These factors are: supplier performance score 1408 (based on historical supplier performance information), supplier location score 1412 (the degree to which the supplier site location can positively or negatively impact supply chain and/or logistics operation(s) performance), supplier financial score 1416(the degree to which the supplier financial condition can positively or negatively impact supply chain and/or logistics operation(s) performance) , and supplier geo-political score 1420 (the degree to which the geo-political location of the supplier can positively or negatively impact supply chain and/or logistics operation(s) performance). The risk category is determined by the risk manager for each tier 1 seller server 204, tier 2 assembler server 212, first, second, . . . nth tier 3 component manufacturer server 216a-n, and first, second, third, . . . mth tier 4 material (e.g., part and/or component) supplier server 220a-m, and the performance, location, financial, and geo-political scores are determined by the analytical engine, for each tier 1 control tower server 204, tier 2 assembler server 212, first, second, . . . nth tier 3 component manufacturer server 216a-n, and first, second, third, . . . mth tier 4 material supplier server 220a-m. The performance, location, financial, and geo-political scores can be assigned by the analytical engine and/or administrators. The supplier risk category and performance, location, financial, and geo-political scores are not limited to suppliers but may be assigned not only to the tier 1 seller 100, tier 2 assembler 104, first, second, . . . nth tier 3 component manufacturer 108a-n, and first, second, third, . . . mth tier 4 material supplier 112a-m but also freight carriers between and among two or more of the foregoing.

Other graphical displays are provided in U.S. Design application Ser. Nos. 29/410,218, 29/410,221, 29/410,226, 29/410,227, and 29/410,230, each of which is incorporated herein by this reference.

The supply chain and logistics manager 336 can include other components not shown in FIG. 4. By way of example, it can include a remote access device to service a target device. The target device has a target-device input/output interface and the remote access device has a remote-access-device input/output interface that are operatively coupled at the hardware level. A wireless communication link is established between the remote access device and a communications network to establish a communication link between a computer remote from the target device and from the remote access device. Service instructions are received from the computer at the remote access device over the communication link. The received service instructions are transmitted through the coupled input/output interfaces to service the target device. Further details are provided in US Patent Application Publication No. 2012/0254345, which is incorporated herein by this reference.

### The Engineering Services Manager 340

The engineering services manager 340 provides product or component design services, schedules product or component design, manages engineering processes, and monitors product or component design activities. Engineering processes include not only new product or component design activities but also modification of existing product or component designs and specifications. With reference to FIG. 8, the engineering services manager 340 includes a data collection and maintenance module 800, a project search engine 804, a project scheduling module 808, an analytical engine 812, a monitor 816, and a reporting module 820, connected by a local area network or bus 624.

The data collection and maintenance module 800 collects engineering and procurement information from tier 1, 2, 3, and/or 4 entities in the supply chain and from accessible information source(s) 224 and stores, maintains, and tracks, by project, engineering documents. Accessible information source(s) include, for example, enterprise databases recording engineering and project information, information management systems, management information systems, enterprise resource planning systems, customer relationship management systems, knowledge management systems, enterprise information system, and the like.

The data collection and maintenance module 800 can parse the collected information, extract relevant information items, and optionally tag the extracted information items. The data collection and maintenance module 800 can include a database management function that stores, updates and otherwise manages the data in the database 208 in accordance with a selected data model.

The data structures are typically associated with one or more products and components thereof made, distributed, and/or sold by the enterprises and/or organizations in the supply chain and by competitors thereof. Data structures include product and component designs and formulations, engineering documents (such as specification and/or requirements documents, design drawings, engineering reports, engineering correspondence, and the like), product and component manufacturers and suppliers, raw material, component and product manufacturing costs, prices and profit margins, and other procurement and engineering information. Tags associated with the stored and/or maintained data by the data collection and maintenance module 800 typically include product type, component type, manufacturer and/or supplier identifier.

The database 208 can aggregate devices and/or components by including supply chain data, private engineering data, and public engineering data. Supply chain data includes procurement data associated with the devices and/or components, including but not limited to price, manufacturer, manufacturer preferred status, device availability, delivery terms, approved manufacturer's list (“AML”) frequency, and demand. The majority of supply chain data is developed internally and depends on the business relations of the company. However, some supply chain data (e.g., standard price lists, etc.) may be available from public sources. Private engineering data includes but is not limited to the area, footprint, pinouts, parametric data, component geometries, etc., associated with the devices and/or components. Public engineering data includes data similar to private engineering data, except that public engineering data is provided by one or more databases in an accessible information source 224.

The data structures can include, for each device and/or component, an indicator or tag respecting restrictions on use of the device and/or component information in other designs. This is particularly important where the control tower services platform services multiple independent supply chains, which may be associated with competitors. In such circumstances, one competitor would not wish to share confidential device and/or component information with another competitor. The tag can indicate use restrictions and the reason for such restrictions, such as confidential or proprietary information, contractual and/or higher management restriction on how the device and/or component information can be used, and the like.

The data structures can provide a “cradle-to-grave” history of a device or component. A common identifier is used to reference records pertaining to design, manufacture, and sale of the device or component, thereby enabling a user to view the entire set of data records of the device or component simply by searching for the identifier. Examples of common identifiers include project identifier, device or component identifier, work item or order number, and the like.

The product search engine 804 receives a device criteria (e.g., a parametric value, procurement value, etc.) and/or other design rules from an engineer or designer, queries the database 208 and/or accessible information source(s) 224 for devices (and/or components) corresponding to the device criteria and/or design rules, queries the database 208 for procurement data and/or engineering information associated with the corresponding located device(s) (and/or component(s)), presents the located device(s) (and/or component(s)) to the engineer or designer based on the procurement data, and receives input from the engineer or designer identifying one of the presented located device(s) (and/or component(s)) as a selected device (and/or component). The located device(s) (and/or component(s)) can be sorted based on one or more procurement values (e.g., manufacturer, supplier, manufacturer and/or supplier name and/or location, manufacturing cost, price, profit margin, availability, manufacturer and/or supplier status, etc.), and presented to the engineer or designer in a ranked list. Objects representative of the selected located device(s) (and/or component(s)) are then entered into a design file, and the objects are associated with the engineering and/or procurement data corresponding to the device (and/or component(s)) described by the device criteria. The device (and/or component(s)) can be identified by a project name and/or number. The objects can be associated with the engineering data by embedding the engineering data in the file object. Alternatively, data can be associated with the objects via links to the database. Types of engineering data that can be associated with design file objects include, but are not limited to, device footprint data, device pinout data, device physical dimension data, parametric data, subcomponents, component raw materials (e.g., material safety data sheet) and packaging data. Connection data and annotation data can be entered into the design file objects by the engineer or designer. Feedback can be provided from one or more supply chain members to the engineering services manager by updating the design rules stored in the database 208. Feedback can include design changes to enable more effective and/or efficient manufacture, cheaper raw material and/or subcomponent substitutions, and the like. Additional details regarding the product search engine 804 are described in U.S. Pat. Nos. 7,712,058 and 7,134,096, each of which is incorporated herein by this reference.

The project scheduling module 808 maintains a device or component design schedule to be adhered to by engineering personnel. The device or component design schedule can include dates, performance milestones, objectives, or targets, and actual performance information relative to scheduling requirements.

The analytical engine 812 can use techniques noted above for the analytical engine 712 to identify potentially disruptive events to compliance with the project schedule. Events include any of the events noted above with respect to the supply chain and/or logistics operation(s) and other events potentially impacting the design team, such as personnel loss, personnel reassignment, failed or unsatisfactory device and/or component tests, and the like.

The monitor 816, based on input from the analytical engine 812 and project scheduling module 808, identifies actual and/or potential events of noncompliance with the project scheduling and provides, via the reporting module 820, appropriate alerts to management well in advance of noncompliance with the design schedule. This can permit appropriate remedial actions to be taken, such as assigning additional personnel or changing current assignments of already assigned personnel, to maintain the project on schedule.

The reporting module 820 receives queries from authorized requestors, collects the information (such as from one or more of the other components of the engineering services manager), and provides the information to the information retrieval and presentation module 344 for presentation, via control tower server 204, to the requestor, which can be one or more of a customer server 308, client communication device 312, and supply chain member server 316.

### The Information Retrieval and Presentation Module 344

The information retrieval and presentation module 344 receives, from the security module 320, requests for information, directs the requests to the appropriate services module, receives the response, determines the capabilities of the communication device originating the request, filters and formats the response, according to predetermined rules, to comply with the capabilities of the communication device, and forwards, via the control tower server 204, the filtered and formatted response to the communication device. The communication device can be a client communication device 312, customer server 308, supply chain member server 316, and the like. Exemplary communication devices include laptop computer, personal computer, tablet computer, wireless phone, personal digital assistant, and the like.

The capabilities and features of communication devices vary. For instance, devices can have limited graphical content display capabilities and/or internal memories. Other device capabilities and features include processing speed, memory types and usage, satellite positioning system receiver (e.g., GPS), personal information manager (“PIM”), camera, Short Message Service (“SMS”) messaging, Multimedia Message Service (“MMS”) messaging, video player, accelerometer, proximity detector, browser, software types and versions, display color and resolution, operating system, firmware release and type, augmented reality, scanner, gesture recognition, navigation, mobile visual (image) search, speech recognition, and native user interface elements. Communication devices can currently have limited bandwidth to convey information for graphical presentation to the user. Bandwidth limitations can vary over time in response to movement of the communication device, decreased or increased bandwidth consumption by other communication devices, and the like.

The information retrieval and presentation module 344 can provide visibility into one or more selected operations being monitored by the control tower services platform 100. By way of example, a tier 1 seller can inquire as to the status of a product lot or shipment, a tier 2 assembler can inquire as to the status of a device or component to be used in product assembly, a tier 1 seller can inquire as to the status of a device and/or component design project, an employee of the enterprise or organization operating the control tower services platform 100 can inquire about the availability of specified physical resources, and so on.

### The Innovation Services Module 348

The innovation services module 348 manages innovation processes and identifies, protects, and/or tracks patent protection of innovative ideas, inventions, modifications, adaptations, improvements, trade secrets, and other valuable information. Identification can include embedding one or more tags into data structures describing the valuable information. The tags indicate a type of valuable information, e.g., trade secret, confidential non-trade secret, patentable information, patent pending information, and the like, distribution and/or use restrictions on the information, e.g., distribution and use restrictions on trade secret information, products, devices, and/or components embodying and/or using the valuable information, ownership of the valuable information, and the like. Protection refers primarily to patent protection of the valuable information. Protection can include links to documentation and/or records of internal or external counsel regarding patent protection, documentation, such as invention submissions or disclosures, maintained by the enterprise or organization operating the control tower services platform 150, publicly available records regarding patent protection, such as pertinent records of the United States Patent Office. Tracking refers to a current state of the protection. Examples include whether and where issued patents exist, whether and where patent applications are filed and/or pending, whether and when the valuable information was approved for patent protection, and the like.

The innovation services module 348 can receive, from the engineering services manager 340 and/or supply chain and logistics manager 336, notifications when a product, device, and/or component is ready for review to identify potentially patentable subject matter and/or freedom to practice issues or for clearance of potential third party patent infringement. The notification, for instance, can be based on embedded triggers in the product design scheduling.

### The Risk Manager 352

The risk manager 352 monitors selected activities and determines and assigns a risk parameter to a selected activity failing to satisfy one or more requirements and/or specifications. The monitored activity can include, for example, a supply chain operation, a logistics operation, and a device or component design activity. The requirement and/or specification can be compliance with a deadline (e.g., delivery deadline, shipping deadline, and milestone, objective, and/or target in a device or component development or delivery schedule), product, device, or component performance specification or parameter, and the like.

The risk manager 716 applies a rule or policy set or template to the information or output received from the analytical engine 712 and provides reporting information to the reporting module 720 as noted above and/or another service module. The reporting information may include not only a warning (with an associated probability and/or level of confidence) that a noncompliant event will occur and optionally a recommendation on how to mitigate and/or avoid the noncompliant event. Mitigation recommendations include, for example, ordering products from a different facility of the tier 2 product assembler 104 and/or from a different tier 2 product assembler 104, using a type of freight company or specific freight company to provide faster incoming and/or outgoing product shipment, cancelling or altering an existing order (e.g., increase or decrease product quantity and/or delay or expedite product shipment date) with a tier 2 product assembler 104 and/or downstream distribution chain entity, shipping product from a different tier 1 facility to the selected destination in the distribution chain to offset the noncompliant event, and ship a different product to the selected destination in the distribution chain to offset the noncompliant event. The recommendation can be performed automatically by the risk manager 716.

Risk can be determined given a time series of data collected by the data collection and maintenance module. This data can be presented either as a first linear array (1×N) where N is the number of factors collected. The factors can include one or more of the factors, parameters, or supply chain and/or logistics operation(s) characteristics identified herein. The factors can include risk factors, such as economic risk, environmental risk, geopolitical risk, societal risk, and technological risk. A transfer function (N×M) can relate the collection of such (risk) factors to variability (risk) of critical factors,(be they cost, time to delivery, the same or another risk factor, etc.), which is the (1×M) linear array. The (1×N) linear array can also be transformed into a single number or factor or given a coloration indicative of an “overall” metric of risk (variability). The overall metric of risk can be a supply chain and/or logistics operation(s) health index or risk.

The risk manager 716 can identify problems or choke points or bottlenecks in the supply chain and/or logistics operation(s) and/or generate alerts and/or notifications to administrators of predetermined events (such as a monitored parameter falling below or exceeding a selected threshold. The risk manager 716 at the control tower service platform 150 can do this, for example, by analyzing the reported performance information using advanced planning and scheduling techniques by which raw materials and production capacity are optimally allocated to meet demand. A performance risk can be associated with each of the tier 1 seller, tier 2 product assembler 104, part/component manufacturer 108, and tier 4 material supplier 112 based on factors, such as performance rating, geographic location of the enterprise and/or organization relative to the geographic locations of the upstream enterprise and/or organization (if any) supplying the recommended enterprise and/or organization and of the downstream enterprise and/or organization (if any) receiving material and/or product from the enterprise and/or organization, and/or the likelihood of a disruptive event impacting the enterprise and/or organization and/or a shipment line associated therewith.

The risk manager 716 can determine a possible or potential financial impact on the enterprise or organization as a result of the event. The possible or potential financial impact can be done on one or more affected product lines and/or for the enterprise or organization as a whole. A risk or probability can be assigned to each possible or potential financial impact to form a type of risk portfolio. Pricing input from a price monitoring module 356 can assist in determining product price increases as a result of the event. Decreases in demand for the product can be projected based on the price increase. The decreased demand can then be converted into a projected gross sales revenue to be used in the financial forecast. The possible or potential financial impact can be determined for an instance of an event or proactively if a selected event were to occur. Electronic manufacturing services, in particular, would benefit from this type of financial impact analysis.

The risk manager 716 can determine, quantify, and assign risk factors to a selected object using one or more techniques. Examples include manufacturing process management or MPM techniques, enterprise resource planning (“ERP”) techniques, materials requirement planning (“MRP”) techniques, scheduling algorithms, pattern or template matching (based on historical data patterns and/or on patterns or templates predetermined or predefined by system administrators), simulation modeling, transportation theory, and/or capacity planning.

As will be appreciated, any of the other estimates or projections described herein can include a level of confidence or probability that the estimate or projection is true or false (as appropriate).

### The Supply Chain and Logistics Analyzer 332

The supply chain and logistics analyzer 332 can identify problems or choke points or bottlenecks in the supply chain and/or logistics operation(s) and/or provide recommended changes to the supply chain and/or logistics operation(s) to provide greater reliability, more reliable and faster material and/or part and/or component and/or product manufacture and delivery cycles, more material turns, and reduced cost and waste. The supply chain and logistics analyzer 332 at the control tower service platform 150 can do this, for example, by analyzing the reported performance information using advanced planning and scheduling techniques by which raw materials and production capacity are optimally allocated to meet demand. Recommendations could include restructuring tier 1, 2, 3 and 4 relationships, using differently located facilities for lesser or greater production, using different freight modes and/or carriers, and reconfiguring the layout and/or production unit operations within a selected facility. A performance risk can be associated with each recommendation based on factors, such as performance rating, geographic location of the recommended enterprise and/or organization relative to the geographic locations of the upstream enterprise and/or organization (if any) supplying the recommended enterprise and/or organization and of the downstream enterprise and/or organization (if any) receiving material and/or product from the recommended enterprise and/or organization, and/or the likelihood of a disruptive event impacting the recommended enterprise and/or organization and/or a shipment line associated therewith.

The supply chain and logistics analyzer 332 can use cost information received from the cost monitoring module 356 to identify potential modifications to a selected supply chain and/or logistics operation to save money. For example, labor arbitrage, or differences in labor rates, differences in raw material prices, differences in governmental regulations and restrictions, differences in facility capital and operating costs, and other cost differences can cause the supply chain and logistics analyzer 332 to recommend relocating part of the supply chain to a less expensive country.

The supply chain and logistics analyzer 332 can use scheduling algorithms to determine and/or identify recommended changes to the supply chain and/or logistics operation(s).

The supply chain and logistics analyzer 332 can use pattern or template matching to determine and/or identify recommended changes to the supply chain and/or logistics operation(s). The patterns or templates can be based on historical data patterns for the selected supply chain and/or logistic operation and/or for other supply chain chains and/or logistic operations (which may involve different products, devices, and components and/or be associated with different customers) and observed administrator responses and/or on patterns or templates predetermined or predefined by system administrators. The supply chain and logistics analyzer 332 can search by one or more of the time, location and setting. For example, for an earthquake in Asia having a specified severity level, the supply chain and logistics analyzer 332 can search for other earthquake events in Asia within the last three years having a similar severity level and determine the changes to the currently selected or other supply chain and/or logistics operation(s) to determine a currently recommended set of changes.

The supply chain and logistics analyzer 332 can use simulation modeling to determine and/or identify recommended changes to the supply chain and/or logistics operation(s).

The supply chain and logistics analyzer 332 can use transportation theory to determine the optimal transportation and/or allocation of supply chain and/or logistics operation(s) resources. Examples of transportation theory functions or principals include Wassertein metric, transport function, and the Hungarian algorithm.

The supply chain and logistics analyzer 332 can use capacity planning, which is the process of determining the production capacity needed by the supply chain and/or logistics operation(s) to meet changing demands for the branded products. In the context of capacity planning, “design capacity” is the maximum amount of work that the supply chain and/or logistics operation(s) is capable of completing in a given period, “effective capacity” is the maximum amount of work that the supply chain and/or logistics operation(s) is capable of completing in a given period due to constraints such as quality problems, delays, material handling, etc.

The supply chain and logistics analyzer 332 can use other variables and/or algorithms to determine and assign a relative health factor to the supply chain and/or logistics operation(s) and/or to recommend a change to the selected supply chain and/or logistics operation(s). For example, the supply chain and logistics analyzer 332 can employ a metric—CpX, which can be a measure of risk and capable of substantially optimizing the supply chain and/or logistics operation(s). The metric can be determined through the collection, aggregation, and transformation of supply chain and/or logistics operation(s) data, including performance information, and, when optimized, can modify system parameters of the logistic or supply chain system to reduce and/or optimize risk profiles for any selected supply chain parameter or object, typically a given product, a selected product line, and/or a customer account.

As noted in connection with the risk manager 352, risk can be determined given a time series of data collected by the data collection and maintenance module. The overall metric of risk can be used by the supply chain and logistics analyzer 332 as a supply chain and/or logistics operation(s) health index or risk. After optimization of the collected factors and comparing real data, the transfer function (N×M) can be substantially optimized by the supply chain and logistics analyzer 332—and it can represent the operational parameters of the supply chain and/or logistics operation(s) (for better or worse).

To optimize the supply chain and/or logistics operation(s) (or substantially minimize the magnitude of the 1×M scalar), the supply chain and logistics analyzer 332 can apply a reverse transform function and fine tune the factors in the (1×N) linear array to effect the change—meaning for each optimal element 1 to . . . N, actual operations (e.g., order cycle, warehouse sizing, assembly line capacity, order aggregation, price, etc.) will be changed or modified to achieve the desired risk profile. Alternatively, the supply chain and logistics analyzer 332 can set risk protection, configured or determined at various levels, by setting the scalar (high, medium, low) and changing the various offerings to meet the customer need—as some customers can deal with risk better than others).

Alternatively, given a multiple set of (1×N) and (1×M), the supply chain and logistics analyzer 332 can determine a multitude or plurality of transfer functions, particularly where state or situational differences exist among one or more of business segments, product portfolios, customers profiles, etc. In such cases, the 1×M (minimum) linear array would likely be different, as would the substantially optimal 1×N linear array.

In cases where each supply chain and/or logistics operation(s) situation or state is mutually exclusive, the solutions themselves will be likewise, mutually exclusive. In new scenarios, the linear combination of such solutions would be applicable in direct proportion to their contribution, provided that there is no correlation between the solutions.

The supply chain and logistics analyzer 332 can use MPM to analyze a selected supply chain and/or logistics operation and provide recommended changes. MPM is a collection of technologies and methods used to define how products are to be manufactured. MPM differs from ERP/MRP, which is used to plan the ordering of materials and other resources, set manufacturing schedules, and compile cost data. MPM can provide the central repository for the integration of all these tools and activities and aid in the exploration of alternative production line or sequence or cycle scenarios; making assembly lines more efficient with the aim of reduced lead time to product launch, shorter product times and reduced work in progress (WIP) inventories as well as allowing rapid response to product or product changes.

The supply chain and logistics analyzer 332 can intelligently relate the geographical location of each facility in each tier with a partner facility in a higher tier and/or the relative shipping costs and/or standard deviation thereof from a facility in one tier to a partner facility in a higher tier and control relationships to reduce or substantially minimize transportation costs. This mapping, which can be in the form of a unit shipping cost from each facility in a lower tier to each facility in the adjacent higher tier, can also be used to intelligently order materials and/or components and/or products from a lower tier facility to an upper tier facility experiencing a supply constraint so as to maintain lower transportation or shipping costs.

The supply chain and logistics analyzer 332 can intelligently relate the geographical location of each facility in each tier with a partner facility in a higher tier and/or the relative shipping time and/or standard deviation thereof from a facility in one tier to a partner facility in a higher tier and control relationships to reduce or substantially minimize transportation time. This mapping, which can be in the form of a shipping time from a point of loading at each facility in a lower tier to arrival at each facility in the adjacent higher tier, can also be used to intelligently order materials and/or components and/or products from a lower tier facility to an upper tier facility experiencing a supply constraint so as to maintain lower transportation or shipping times to substantially minimize disruptions in the distribution chain.

The supply chain and logistics analyzer 332 can intelligently relate the rate of turnover or unit manufacturing time and standard deviation thereof from time of receipt of an order for a manufactured item to the time of shipping of the manufactured item for each facility in each tier, optionally associated with a shipping time required to ship the manufactured item to a partner facility in a higher tier and/or standard deviation thereof and control relationships to reduce or substantially minimize unit product manufacturing time. This mapping can also be used to intelligently order materials and/or components and/or products from a lower tier facility to an upper tier facility experiencing a supply constraint so as to maintain lower product manufacturing and transportation or shipping times to substantially minimize disruptions in the distribution chain.

The supply chain and logistics analyzer 332 can intelligently relate the unit manufacturing cost, or price, of material and/or component and/or product and/or standard deviation thereof from each facility in each tier and optionally unit shipping costs from the facility in a lower tier to a partner facility in a higher tier and/or standard deviation thereof, and control supply and facility relationships to reduce or substantially minimize unit costs and/or prices at the lower tier facility or as delivered at the destination partner facility in the adjacent higher tier. This mapping, which can be in the form of a unit cost or price, optionally unit shipping cost from each facility in a lower tier to each facility in the adjacent higher tier, and total unit cost or price as delivered, can be used to intelligently order materials and/or components and/or products from a lower tier facility to an adjacent upper tier facility so as to maintain lower transportation or shipping costs.

In any of the above mappings, each facility can have, in the adjacent lower tier and adjacent higher tier, order of partner facility preferences in the event of a need to order additional material and/or component and/or product to an upper tier facility experiencing a supply constraint so as to maintain lower unit costs and/or prices at the source facility and/or unit transportation or shipping costs and/or total unit costs and/or prices as delivered. In this manner, when a disruptive event adversely impacts supply from a facility or a facility is otherwise unable to meet an existing or new order for material and/or component and/or product the supply chain and logistics analyzer 332 can easily select a next preferred supplier and forward the order or unsatisfied portion of the order to the next preferred facility.

As will be appreciated, any of the other estimates or projections described herein can include a level of confidence or probability that the estimate or projection is true or false (as appropriate).

### The Cost Monitoring Module 356

The cost monitoring module 356 monitors long term contract and spot market prices and/or costs on a selected object, such as materials and/or parts and/or components and/or products, labor, physical facilities (rental and/or purchase prices), transportation or shipment, and generates alarms or notifications when the monitored prices change upwards or downwards beyond specified thresholds and/or provides pricing or cost information to the supply chain and logistics analyzer 332 for use in evaluating and recommending changes to a selected supply chain or logistics operation. This can be done effectively by identifying all materials and/or parts and/or components within a selected product. For example, a bill of materials can provide visibility into the various materials and/or parts and/or components of a selected product. An integrated circuit board, for instance, includes a broad number of raw materials, such as silicon, dopants, conductive metals for traces and other conductive structures, and device subcomponents, such as microprocessors, memory modules, etc., and is itself a device used in many end products. The cost monitoring module 850 would monitor prices not only for the raw materials but also for the subcomponents and the device itself. Sudden changes in raw materials prices can provide an advance indication of price changes in the device. This can be used by the cost monitoring module 850 not only to estimate the resulting device price but also indicate to administrators that additional inventory of the device should be acquired before the price changes. An example of a cost estimation algorithm is to determine how much of the raw material is used in the device and the net total increase in cost for the device manufacturer. This net cost increase can be added to the current price to provide a fairly reliable cost estimate.

### Operation of the Control Tower Services Platform 150

### Operation of the Security Module 320

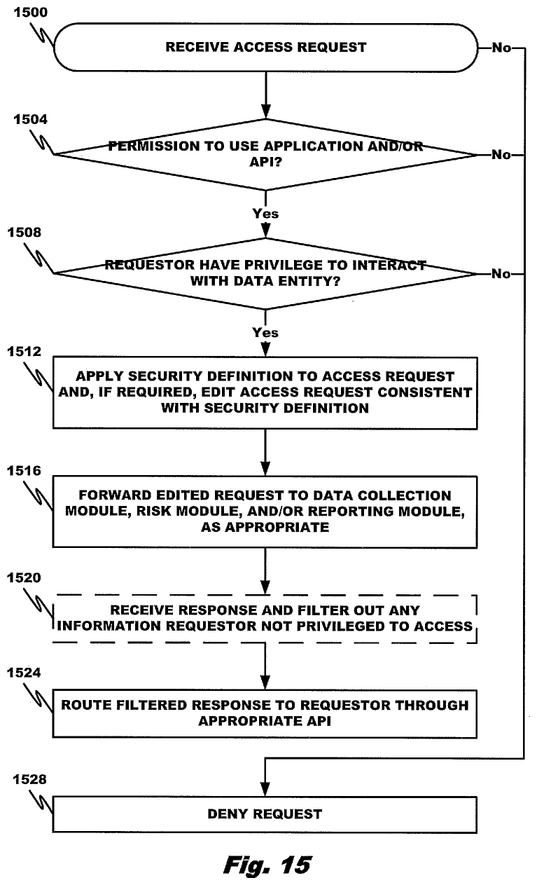

With reference to FIG. 15, the operation of the security module 320 will be discussed. In step 1500, the control tower services platform 150 receives an access request, such as a query, command, or request. The access request can be from a platform administrator or user or from an administrator or member of an enterprise or organization in a supply chain monitored by the platform 150 (hereinafter “requestor”).

The security process begins in decision diamond 1504, in which the security module 320 determines whether the requestor has permission to use the application to which the access request is directed and the API associated with the application or function or feature of the application to process the access request.

When the requestor has permission to use the application and API, the security module 320, in decision diamond 1508, determines whether the requestor is privileged to interact with the data entity. As noted, this query determines whether the requestor has a specified role privileged to create, read, update, and delete the specified data object.

When the requestor does not have permission to use either the application or the specific API of the application involved in processing the access request or is not privileged to interact with the data entity or object, the security module 320 proceeds to step 1528 and denies the request.

When the requestor is privileged to interact with the data entity or object, the security module 320 proceeds to step 1512 and applies a security definition to the access request and, if required, edits or reconfigures the access request consistent with the applied security definition.

In step 1516, the security module 320 forwards the edited request to the application, e.g., the physical infrastructure manager 324, cost monitoring module 356, supply chain and logistics analyzer 332, supply chain and logistics manager 336, engineering services manager 340, innovation services module 348, and/or risk manager 352, for processing.

In optional step 1520, the security module 320 receives the response and filters out any information that the requestor is not privileged to access. This is a precautionary step in the event that a database error has caused information to be retrieved improperly.

In step 1524, the security module 320 routes the response to the requestor optionally through the appropriate API.

### Operation of the Physical Infrastructure Manager 324

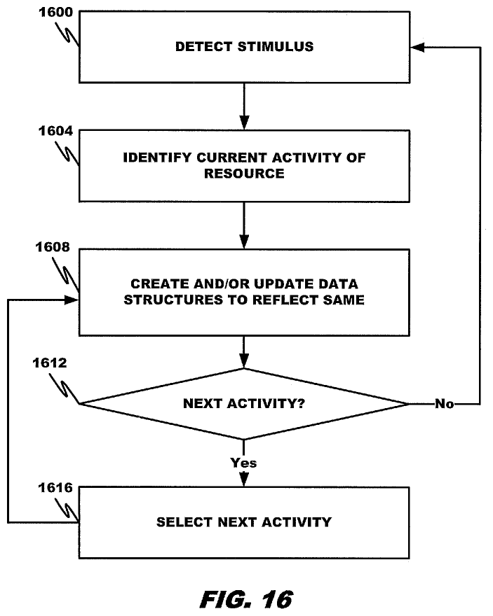

Operation of the activity identification module 604wi11 be described with reference to FIG. 16.

In step 1600, the activity identification module 604receives a stimulus. Stimuli include, for example, a request from a client communication device, a notification received from a services module, passage of time, and the like.

In step 1604, the activity identification module 604 identifies a current activity of a selected resource. For example, the activity identification module 604 identifies current work assignments of each employee and consultant and current operations related to a selected supply chain and/or logistics operation being performed at each facility and/or by each service provider in the supply chain and logistics infrastructure.

In step 1608, the activity identification module 604 causes the data collection and maintenance module 600 to create and/or update data structures to reflect the identified current activity.

In decision diamond 1612, the activity identification module 604 determines whether there is a next identified activity. When there is a next identified activity, the activity identification module 604 returns to step 1608. When there is no next identified activity, the activity identification module 604 returns to step 1600 to await a next stimuli.

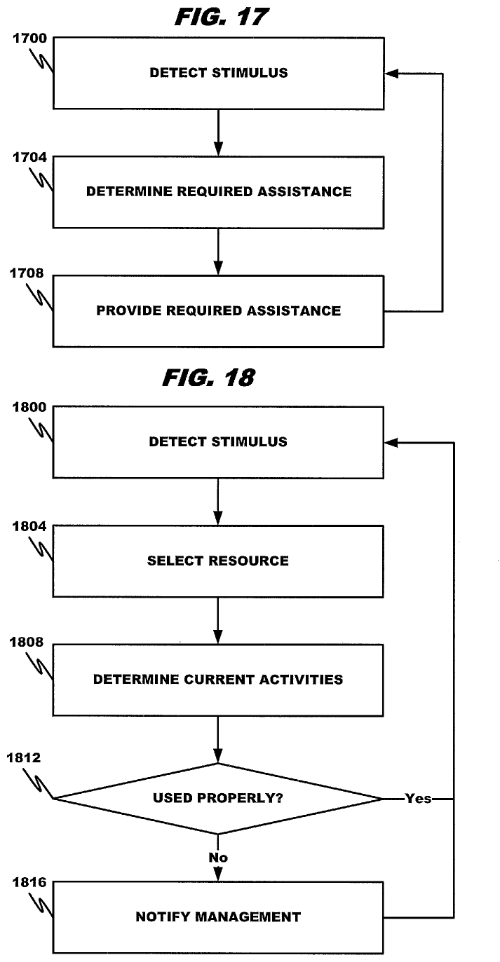

With reference to FIG. 17, the operation of the human resource manager will now be described.

In step 1700, the human resource manager detects a stimulus, such as any stimulus referenced above.

In step 1704, the human resource manager determines what assistance is required.

In step 1708, the human resource manager provides or causes another services module to provide the required assistance.

As noted, the human resource manager can provide services (or assistance) to employees and consultants to address cultural differences, different regulatory and statutory requirements and restrictions at each facility, language differences, time zone differences, CSER, and other obstacles and hindrances to employee and consultant interactions and confirm that employees and consultants are trained, assigned, and described properly. The human resource manager 608, for instance, can provide cultural descriptions (e.g., acceptable and unacceptable behavior in each culture) to coach employees and consultants on how to work together, descriptions of regulatory and statutory requirements and restrictions at each facility, automated translators to enable communications to be converted readily between languages, descriptions of enterprise or organizational rules and policies applicable to each physical resource or interaction between resources, e-mail and social networking capabilities similar to Linkedin™ to enable employees and consultants to interact effectively, and harmonizes employee and consultant training in all cultures to ensure all like employees and consultants receive similar training.

Referring now to FIG. 18, additional operations of the human and non-human resource managers will be described.

In step 1800, the manager detects a stimulus, which can be any of the stimuli referenced above.

In step 1804, the manager selects a human or non-human resource.

In step 1808, the manager determines a current activity and/or configuration of the resource. Input from the activity identification module can assist in this determination.

In decision diamond 1812, the manager determines whether the selected resource is being used properly. The human and non-human resource managers determine how human physical resources are currently being used and confirm that the resources are being employed and described properly (e.g., in compliance with CSER, regulatory and statutory requirements and restrictions, and corporate rules and policies), effectively (e.g., being used as designed and intended), and efficiently (e.g., being used at or near design capacity). For example, the human resource manager can determine and track, hierarchically, employee and consultant positions in the organization, and confirm, based on input from the activity identification module, that each employee and consultant is, based on historically and currently performed work assignments, properly described in terms of his or her skills and experience and/or engaged currently in appropriate activities for his or her skills and experience, job title, and hierarchical position in the organization.

When the selected resource is being used properly, the manager returns to step 1800.

When the selected resource is not being used properly, the manager notifies management in step 1816 and then returns to step 1800.

### Operation of the Cost Monitoring Module 356

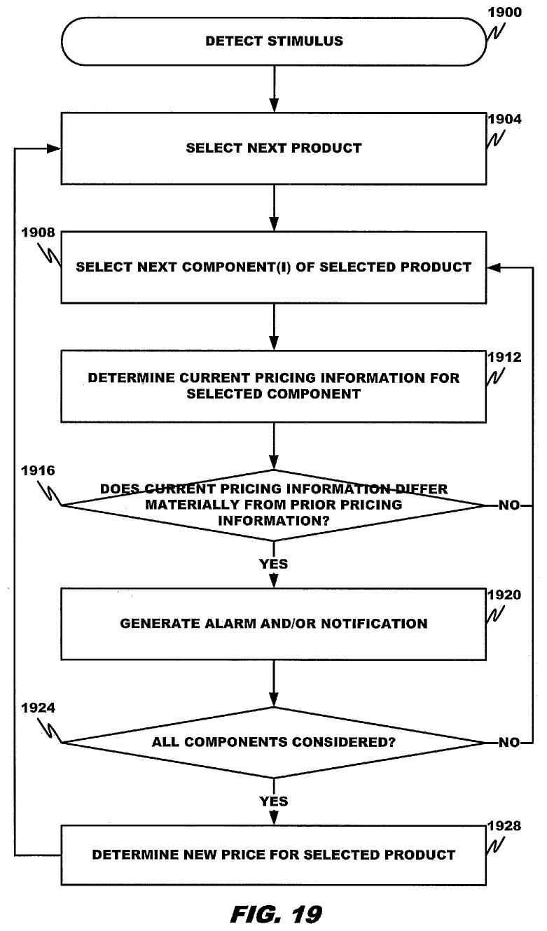

The operation of the cost monitoring module 356 will now be discussed with reference to FIG. 19.

In step 1900, the cost monitoring module 356 detects a stimulus. The stimulus can be, for example, expiration of a selected time period, request for cost or financial information, and the like.

In step 1904, the cost monitoring module 356 selects a next product for consideration. This step can be done on a supply chain-by-supply chain basis and, for a given supply chain, for one or more selected enterprises or organizations within the supply chain. For example and with reference to FIG. 2, the product can be a product sold by one or more of a tier 1 seller, tier 2 product assembler 104, first, second, . . . nth tier 3 part/component manufacturer 108a-n, or first, second, third, . . . mth tier 4 material supplier 112a-m.

In step 1908, the cost monitoring module 356 selects a next component (I) of the selected product. As noted, the component can be a raw or processed material, formulation, device, or other component.

In step 1912, the cost monitoring module 356 determines a current cost information for the selected component. This is typically done using one or more accessible information source(s) 224, such as by browsing the Web.

In decision diamond 1916, the cost monitoring module 356 determines whether the current cost information for the selected component differs materially from a previously determined or currently realized cost for the component. “Materially” is typically determined by one or more thresholds. If the price rises or falls in excess of a predetermined threshold, the cost change is deemed to be material.

When a price change is material, the cost monitoring module 356, in step 1920, generates an alarm and/or notification to an administrator of the pertinent enterprise and/or organization.

In decision diamond 1924, the cost monitoring module 356 determines whether all components for the selected product have been considered.

When there is no material cost change (decision diamond 1916) or all components have not been considered, the cost monitoring module 356 returns to step 1908 and selects a next component for cost analysis.

When all components have been considered, the cost monitoring module 356, in step 1928, determines a new price for the selected product.

The cost monitoring module 356 then returns to step 1904 and selects a next product for analysis.

The cost monitoring module 356 and analytical engine 712 can determine a financial impact on a supplier of the product and/or downstream user of the product. The financial impact analysis can be done for the selected product or across all product lines of the supplier and/or downstream user and/or for the supply chain as a whole.

As noted, the cost monitoring module 356 can obtain financial or cost information on objects other than products, such as labor, raw materials, shipping, contract manufacturing, design and engineering, and the like. This information can be provided to the supply chain and logistics analyzer 332 for use in analyzing and recommending changes to a selected supply chain or logistics operation.

### Operation of the Supply Chain and Logistics Analyzer 332

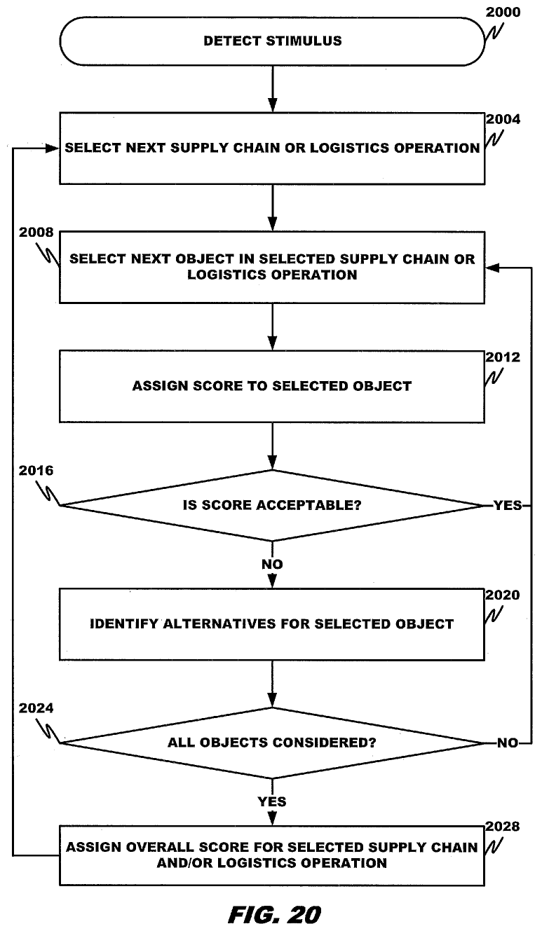

The operation of the supply chain and logistics analyzer 332 will now be discussed with reference to FIG. 20.

In step 2000, the supply chain and logistics analyzer 332 detects a stimulus. The stimulus can be, for example, expiration of a selected time period, request for supply chain or logistics operation analysis, and the like.

In step 1904, the supply chain and logistics analyzer 332 selects a next supply chain or logistics operation for analysis. This step can be done on an enterprise-by-enterprise (e.g., customer-by-customer) basis and/or product-by-product basis. For example and with reference to FIG. 2, the product can be a product sold by one or more of a tier 1 seller, tier 2 assembler 212, first, second, . . . nth tier 3 component manufacturer 216a-n, and first, second, third, . . . mth tier 4 material supplier 220a-m.

In step 1908, the supply chain and logistics analyzer 332 selects a next object (I) of the selected supply chain and/or logistics operation. As noted, the object can be any of a tier 1 seller, tier 2 product assembler 104, first, second, . . . nth tier 3 part/component manufacturer 108a-n, first, second, third, . . . mth tier 4 material supplier 112a-m, or logistical (or shipping) link between any of the foregoing.

In step 2012, the supply chain and logistics analyzer 332 determines and assigns a score or ranking to the selected object. This can be done using input from the supply chain and logistics manager 336. The score or ranking can be a function, for example, of oneor more of current and/or historic performance information for the selected object, a performance rating, a CpX metric, a risk score, a performance score, a location score, a financial score, and a geo-political score. Problems or choke points or bottlenecks in the selected supply chain or logistics operation can be determined, for example, using one or more of a critical path method algorithm, queueing theory, a scheduling algorithm, a simulation of the selected supply chain or logistics operation, pattern or template matching, manufacturing process management techniques, enterprise resource planning techniques, transportation theory, capacity planning techniques, and a transform function.

In decision diamond 2016, the supply chain and logistics analyzer 332 determines whether the score is acceptable. The acceptability of the score can be determined relative to a predetermined score threshold, policy or rule set, or relative to an object of a supply chain or logistics operation used as a basis of comparison.

When the score is acceptable, the supply chain and logistics analyzer 332 returns to step 2008.

When the score is not acceptable, the supply chain and logistics analyzer 332 proceeds to step 2020 and identifies alternatives to the selected object. The alternative can be based on one or more of information received from the cost monitoring module, the supply chain and logistics manager 336, administration, an object of a supply chain or logistics operation used as a basis of comparison, a selected supply chain or logistics operation template, and the like. The supply chain and logistics analyzer 332 can not only identify problems or choke points or bottlenecks in the supply chain and/or logistics operation(s) but also provide recommended changes to the supply chain and/or logistics operation(s) using one or more of the algorithms discussed above in connection with step 2012.

In decision diamond 2024, the supply chain and logistics analyzer 332 determines whether all objects for the selected supply chain or logistics operation have been considered.

When not all objects have been considered, the supply chain and logistics analyzer 332 returns to step 2008 and selects a next object for analysis.

When all objects have been considered, the supply chain and logistics analyzer 332, in step 2028, determines and assigns an overall score to the selected supply chain and/or logistics operation. The overall score may be a sum, average, median, mode, or other mathematical combination of the scores of the individual objects constituting the selected supply chain or logistics operation. The supply chain and logistics analyzer 332 can determine and assign relative scores for selected supply chain or logistics operation as currently configured and if reconfigured as recommended.

The supply chain and logistics analyzer 332 then returns to step 2004 and selects a next supply chain or logistics operation for analysis.

### Operation of the Supply Chain and Logistics Manager 336

Referring to FIG. 21, the operation of the data collection and maintenance module 700 will be discussed.

In step 2100, the data collection and maintenance module 300 receives a stimulus. Stimuli include, for example, a request from a tier 1 manager, reported performance information received from a lower tier partner, a request from the risk manager 352 and/or scheduling module 704 and/or analytical engine 712, passage of time, and the like.

In step 2104, the data collection and maintenance module 700 selects a (next) supply chain and/or logistics operation(s) node to query for performance information.

In step 2108, the data collection and maintenance module 700 accesses, or receives, the performance information.

In decision diamond 2112, the data collection and maintenance module 700 determines whether there is a next supply chain and/or logistics operation(s) node to be considered for performance information. If so, the data collection and maintenance module 700 returns to step 2104. If not, the data collection and maintenance module 700 returns to step 2100 and awaits the next stimulus instance.

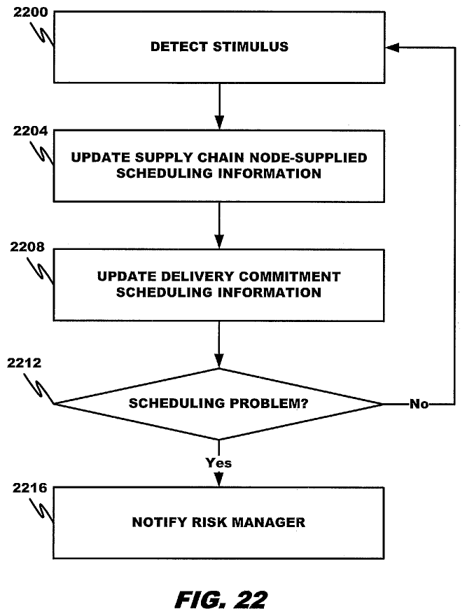

Referring to FIG. 22, the operation of the scheduling module 704 will be discussed.

In step 2200, the scheduling module 704 receives a stimulus. Stimuli include, for example, a request from a tier 1 manager, notification by the data collection and maintenance module 700 of newly received and/or updated reported performance information, a request from the risk manager 352 and/or analytical engine 712, passage of time, and the like.

In step 2204, the scheduling module 704 updates supply chain and/or logistics operation(s) node-supplied scheduling information, or product delivery estimates, based on the reported performance information and/or the internally generated product delivery estimates. The scheduling information includes, for example, projected shipment arrival dates for products from the tier 2 product assembler 104 and required shipment departure dates for branded products to customers, wholesalers, and/or retailers. Each of the shipment arrival and departure dates can be linked to a set of data structures describing the shipment, including shipment source and destination, freight carrier, freight tracking information, current shipment status, shipment contents (by product type and number), date of shipment, and the like).

In step 2208, the scheduling module 704 updates the delivery commitment material and/or part and/or component and/or product scheduling information based on distribution chain performance or scheduling information, supply chain and/or logistics operation(s) requirements, and/or projections.

In decision diamond 2212, the scheduling module 704 compares the results of steps 2204 and 2208 and determines whether there is a product delivery scheduling problem.

When there is a scheduling problem, the scheduling module 704, in step 2216, notifies the risk manager 352.

When no scheduling problem exists, the scheduling module 704 updates the database 208 and returns to step 2200 to await the next stimulus instance.

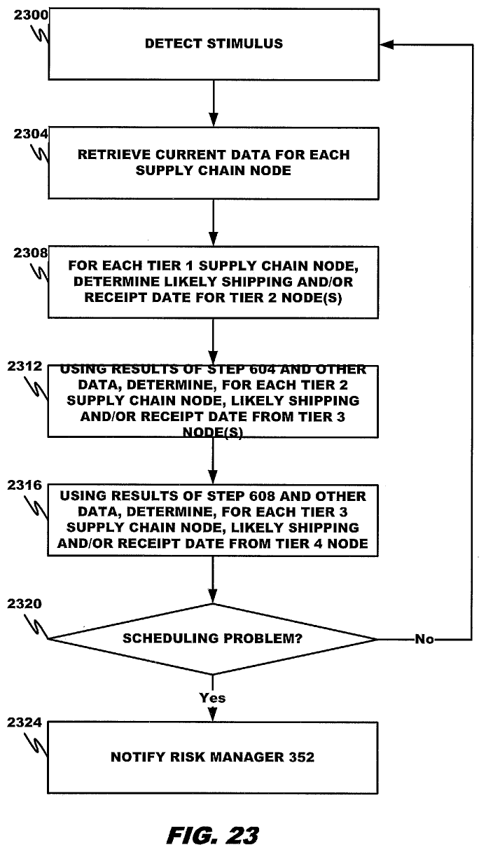

FIG. 23 depicts operation of the analytical engine 712. Upon detection of stimulus in step 2300, the analytical engine 712, in step 2304, retrieves current performance data for each supply chain and/or logistics operation(s) node.

In step 2308, the analytical engine 712, for each tier 1 supply chain and/or logistics operation(s) node or facility, determines a likely product shipping and/or receipt date from each tier 2 node or facility.

In step 2312, the analytical engine 712, using the results of step 2308 and other data, determines, for each tier 2 supply chain and/or logistics operation(s) node, a likely component shipping and/or receipt date from each tier 3 node or facility.

In step 2316, the analytical engine 712, using the results of step 2312 and other data, determines, for each tier 3 supply chain and/or logistics operation(s) node, a likely component shipping and/or receipt date from each tier 4 node or facility.

In step 2320, the analytical engine 712 compares the results of steps 2308, 2312 and 2316 and determines whether there is a material and/or part and/or component and/or product delivery scheduling problem at any tier. As will be appreciated, a material and/or part and/or component and/or product delivery scheduling problem is not limited to material and/or part and/or component and/or product delivery shortfalls relative to distribution chain demands or requirements. A material and/or part and/or component and/or product delivery scheduling problem can also exist when too much product inventory is on hand at a tier 1 facility. In that event, supply chain and/or logistics operation(s) requirements may need to be decreased to delay or reduce material and/or part and/or component and/or product delivery. This determination can be made by comparing on-hand product inventory to distribution chain demands or requirements. When at least a first threshold level but no more than a second threshold level of inventory is on hand (after projected product delivery), a correct inventory level is present at a tier 1 facility. When more than the second threshold level of inventory is on hand (after projected product delivery), an over-inventory condition exists and a modification to the supply chain and/or logistics operation(s) requirements is appropriate.

When there is a scheduling problem, the analytical engine 712, in step 2324, notifies the risk manager.

When no scheduling problem exists, the analytical engine 712 updates the database 208 and returns to step 2300 to await the next stimulus instance.

### Operation of Engineering Services Manager 340

With reference to FIG. 8, the engineering services manager 340 includes the data collection and maintenance module 800, project search engine 804, project scheduling module 808, analytical engine 812, monitor 816, and reporting module 820, connected by the local area network or bus 624. The operations of the data collection and maintenance module 800 and reporting module 820 are similar to those of the data collection and maintenance module 700 and reporting module 720 and will not be discussed separately. The operation of the project search engine 804, which is similar to a search engine, is relatively straightforward and will not be discussed.

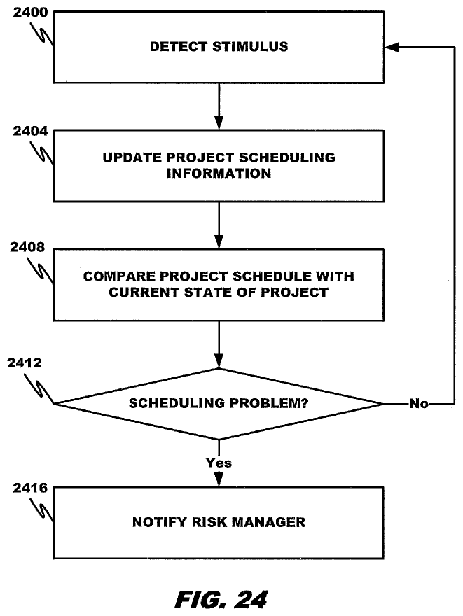

The operations of the project scheduling module 808, analytical engine 812, and monitor 816 will be discussed with reference to FIG. 24.

In step 2400, the project scheduling module 808 receives a stimulus. Stimuli include, for example, a request from a tier 1 manager, notification by the data collection and maintenance module 800 of newly received and/or updated reported project or produce development (performance) information, a request from the risk manager 352 and/or analytical engine 812, passage of time, and the like.

In step 2404, the project scheduling module 808 causes the data collection and maintenance module to update the project scheduling information based on engineering-supplied performance information, or device or component or product design activities. The project schedule itself may be updated or a historic description of completed project activities for comparison to the project schedule.

In step 2408, the analytical engine 812 compares the updated project scheduling information, which describes the current state of the project, against the project schedule to identify compliance and noncompliance with the project schedule.

In decision diamond 2412, the analytical engine 812, based on the results of step 2408, determines whether there is a scheduling problem.

When there is a scheduling problem, the analytical engine 812, in step 2416, notifies the monitor 816. In response, the monitor 816 notifies the risk manager 352 and/or (project) management.

When no scheduling problem exists, control passes to step 2400 to await the next stimulus instance.

### Operation of the Information Retrieval and Presentation Module 344

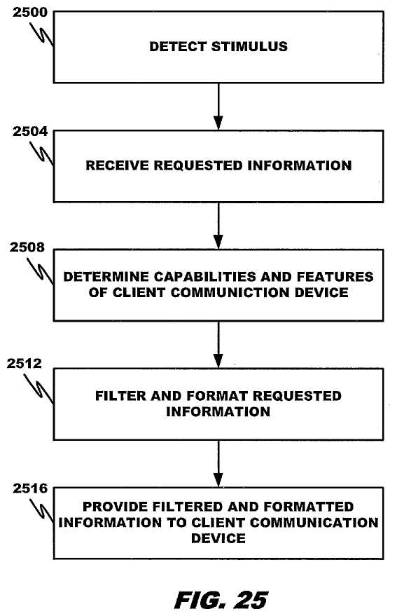

The operation of the information retrieval and presentation module 344 will now be discussed with reference to FIG. 25.

In step 2500, the information retrieval and presentation module 344 receives a stimulus. The stimulus includes receipt, by the control tower services platform 150, of a request for information, receipt of requested information from a services module, and the like.

In step 2504, the information retrieval and presentation module 344 receives the requested information from another services module.

In step 2508, the information retrieval and presentation module 344 determines the capabilities and features of the client communication device requesting the information.

In step 2512, the information retrieval and presentation module 344 filters and formats the requested information for presentation to the client communication device. The filtration removes information that is not compatible or cannot be rendered by the client communication device and formatting formats the filtered information to that it may be rendered by the client communication device.

In step 2516, the information retrieval and presentation module 344 provides, via the network 228 and control tower server 204, the filtered and formatted information to the client communication device.

### Operation of the Risk Manager 352

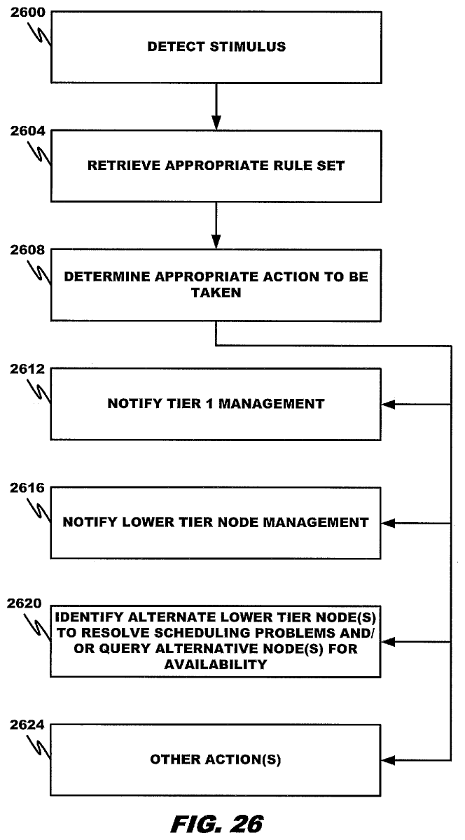

FIG. 26 depicts the operation of the risk manager 352.

In step 2600, the risk manager 352 receives a stimulus. Stimuli include, for example, a request from a client communication device 312, customer server 308, or supply chain member server 316, a notification received from a services module, passage of time, and the like.

In step 2604, the risk manager 352 retrieves the appropriate rule or policy set or template from the database 208.

In step 2608, the risk manager 352 determines, based on a comparison of the material and/or part and/or component and/or product delivery scheduling problem or project scheduling problem with the appropriate rule or policy set or template, an appropriate action to be taken.

A first appropriate action 2612 is to notify management of the material and/or part and/or component and/or product delivery scheduling problem or project scheduling problem.

A second appropriate action 2616 is to notify management of each of the responsible lower tier node(s) of the product delivery scheduling problem or the engineering team responsible for the project of the project scheduling problem and request a proposed mitigation measure to obviate the material and/or part and/or component and/or product delivery scheduling problem or project scheduling problem.

A third appropriate action 2620 is to identify an alternate lower tier node(s) to resolve the material and/or part and/or component and/or product delivery scheduling problem and/or query an alternative node(s) for availability in assisting in mitigating and/or rectifying the material and/or part and/or component and/or product delivery scheduling problem or identify additional engineering personnel for assignment to the project or identify work assignment restructuring of already assigned engineeing personnel to mitigate and/or rectify the project scheduling problem. For example, an alternative facility of a tier partner can be queried to assist in increasing or decreasing production to mitigate and/or rectify the product delivery scheduling problem at a companion facility of the tier partner. An alternative tier partner can be queried to assist in increasing or decreasing production to mitigate and/or rectify the material and/or part and/or component and/or product delivery scheduling problem at a competitive tier partner.

Other appropriate action(s) 2624 include providing a recommendation to tier 1 management of mitigation measure(s) to address and/or rectify the material and/or part and/or component and/or product delivery scheduling problem, a combination of any of the foregoing actions, ship on-hand product inventory from a different tier 1 facility to the demand chain partner, and the like.

The disclosure further encompasses the initialization of the above modules, applications, programs, firmware, and other software prior to execution. As will be appreciated, initialization is the process of locating and using defined values for variable data that is used by a computer program. For example, an operating system or application program is installed with default or user-specified values that determine certain aspects of how the system or program is to function. Typically, these values are stored in initialization files. When the operating system or an application program is first loaded into memory, a part of the program performs initialization; that is, the program searches in the initialization files, finds definite values to substitute for variable values, and acts accordingly. For example, the microprocessor loads and executes the basic input/output system (“BIOS”) and kernel initialization code. Execution of the BIOS code initializes hardware in the computational system. Afterwards the BIOS kicks off the Power-on Self Test (POST), which tests various components in the computational system. As part of this test, the memory controller checks all of the memory addresses with a quick read/write operation to ensure that there are no errors in the memory chips. Read/write means that data is written to a bit and then read from that bit. After the POST is completed successfully, the BIOS attempts to boot up an operating system stored on the computer readable medium. The BIOS reads the first 512-byte sector (sector zero) of the computer readable medium. This is called the Master Boot Record (“MBR”) and it normally contains two components: an operating system-specific bootstrapping program at the start of the MBR followed by a partition table for the computer readable medium. The boot sector is the first sector of a partition, as opposed to the first sector for the computer readable medium. The BIOS loads the contents of the MBR into a specified memory location in the computer readable medium and jumps to that location to start executing whatever code is in the MBR. This causes a physical change in the registers in the microprocessor (which are memory cells built into the microprocessor and contain specific data needed by the microprocessor, particularly the arithmetic and logic unit (“ALU”)), which are set to specific initialization values (including the instruction pointer which holds the memory address for the instruction being executed by the CPU), and the tangible and non-transient computer memory medium (such as the medium containing the BIOS and initialization values).

The disclosure further encompasses the configuration of the computer readable medium during initialization and execution of the above modules, applications, programs, firmware, and other software. When an application is opened, it is loaded into random access memory (“RAM”), which is a specific type of computer readable medium. To conserve RAM usage, many applications load only the essential parts of the program initially and then load other pieces as needed. After an application is loaded, any files that are opened for use in that application are loaded into RAM to make room for new data. When one saves a file and closes the application, the file is written to a specified computer readable medium, and then the file and the application are purged from RAM. The microprocessor requests needed data from RAM, processes the data and writes new data back to RAM in a continuous cycle. To increase processing speed, caches are employed. Caches make the data used most often by the microprocessor instantly available. The primary, or level 1, cache is integrated into the microprocessor. An optional secondary, or level 2, cache can resides on a memory card located near the microprocessor. The level 2 cache has a direct connection to the microprocessor. A dedicated integrated circuit on the motherboard, the L2 controller, regulates the use of the level 2 cache by the microprocessor. Depending on the microprocessor, the size of the level 2 cache commonly ranges from 256 KB to 2 megabytes (“MB”). In most computational systems, most of the data needed by the microprocessor is accessed from the cache. A particular type of RAM, static random access memory (“SRAM”), can be used primarily for cache. SRAM uses multiple transistors, typically four to six, for each memory cell. It has an external gate array known as a bistable multivibrator that switches, or flip-flops, between two states as data is written to, read from, and erased from the cache.

The exemplary systems and methods of this disclosure have been described in relation to a computer network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, the techniques discussed herein are applied to animate objects, such as processing people, particularly at a check point. The Department of Homeland Security can use the management systems to process people more effectively at airport security checkpoints and the Immigration and Naturalization Service can use the management systems to process more effectively at border crossings.

In another alternative embodiment, the techniques discussed herein can be applied to inanimate objects, such as mail or packages, such as by a postal, courier or freight service.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for managing resources of an enterprise, the method comprising:
locating, by a physical infrastructure reporting system, physical resources other than inventory in a supply chain and/or logistics operation of an enterprise, the physical resources other than inventory comprising physical plant facilities, equipment, and employees;
monitoring, by the physical infrastructure reporting system, the physical resources other than inventory in the supply chain and/or logistics operation of the enterprise;
managing, by the physical infrastructure reporting system, the physical resources other than inventory in the supply chain and/or logistics operation of the enterprise according to a multi-tier model, the multi-tire model comprising at least a tier 1 control tower, tier 2 product assembler, tier 3 part or component manufacturer, and tier 4 material supplier;
managing, by an end-to-end services reporting system, enterprise and/or supply chain operations of and services performed by one or more of product innovation, engineering, supply chain, and logistics by:
reading, by a plurality of readers at one or more warehouses, a code or identifier associated with inventory as inventory is received and shipped, the code or identifier being one or more of a universal product code, radio frequency identifier, and electronic product code;
collecting and/or storing, by a supply chain and logistics manager system, supply chain and/or logistics operation performance information based on inventory information received from the plurality of readers;
verifying, by the supply chain and logistics manager system, accuracy of scheduled inventory delivery times;
providing, by the supply chain and logistics manager system, estimates of inventory delivery times;
identifying, by the supply chain and logistics manager system, potential manufacturing and delivery problems;
identifying, by the supply chain and logistics manager system, the effects of expected and unexpected events on supply chain and/or logistics performance; and
generating, by a supply chain and logistics analyzer system, recommended changes to one or more relationships between one or more tiers in the multi-tier model based on the identified effects of the expected and unexpected events; and
providing, by a real-time information reporting system and over an untrusted network, enterprise and/or supply chain information received from the physical infrastructure and end-to-end services reporting systems and the generated recommended changes to one or more client communication devices.

2. The method of claim 1, wherein the physical resources comprise one or more of physical plant, equipment, employees, consultants, and contractors located in different countries.

3. The method of claim 1, wherein the end-to-end services reporting system manages services and operations performed by the physical infrastructure structure in plural of the following areas: product innovation, engineering, logistics, and supply chain configuration and performance.

4. The method of claim 3, wherein the real-time information reporting system manages information related to the physical infrastructure and end-to-end services reporting systems and provides, through one or more security protocols, one or more of (a) real-time visibility into the information based on access privileges of a requestor, (b) identify and proactively address risk, (c) provide applications to provide services useful in execution of the end-to-end services data processing structure, and/or (d) provide cloud-based access by client communication devices and wherein the client communication devices comprise personal, laptop, and tablet computers, smart phones and other cellular devices, personal digital assistants, and/or enterprise or organization communication devices.

5. The method of claim 4, wherein the information is provided internally within the enterprise, externally to unaffiliated customers of the enterprise, and externally to unaffiliated suppliers independent of the enterprise.

6. The method of claim 4, wherein the real-time data processing structure provides cloud-based access by client communication devices and wherein the information is filtered and display formatted properly to reflect the requirements and restrictions of each client communication device, thereby providing communication device awareness.

7. The method of claim 2, further comprising a plurality of the following steps:
enforcing, by a microprocessor executable security module, provisions and policies adopted by a network administrator to prevent and monitor unauthorized access, misuse, modification, or denial of a trusted network and/or trusted network-accessible resources;
identifying, by the supply chain and logistics analyzer system, problems or choke points or bottlenecks in the supply chain and/or logistics operation(s) and wherein the recommended changes provide greater reliability, more reliable and faster material and/or part and/or component and/or product manufacture and delivery cycles, more material turns, and reduced cost and waste;
monitoring, by a microprocessor executable cost monitoring module, long term contract and spot market prices and/or costs on a selected object comprising one or more of materials and/or parts and/or components and/or products, labor, physical facilities, transportation or shipment, and generating, by the cost monitoring module, alarms or notifications when the monitored prices change upwards or downwards beyond specified thresholds and/or providing, by the cost monitoring module, pricing or cost information to a supply chain and logistics analyzer for use in evaluating and recommending changes to the selected supply chain or logistics operation;
providing, by a microprocessor executable engineering services manager, product or component design services, product or component design scheduling, and/or monitoring of product or component design activities;
receiving, by a microprocessor executable information retrieval and presentation module and from the security module, requests for information, directing, by the information retrieval and presentation module, the requests to a selected services module, receiving, by the information retrieval and presentation module, a response, determining, by the information retrieval and presentation module, the features and capabilities of the communication device originating the request, filtering and formatting, by the information retrieval and presentation module, the response according to predetermined rules, to comply with the features and capabilities of the communication device, and forwarding, by the information retrieval and presentation module, the filtered and formatted response to the communication device;
identifying, protecting, and/or tracking, by a microprocessor executable innovation services module, patent protection of innovative ideas, inventions, modifications, adaptations, improvements, trade secrets, and other valuable information; and
monitoring, by a microprocessor executable risk manager, a selected activity and determining and assigning, by the risk manager, a risk parameter to a selected activity failing to satisfy one or more requirements, objectives, and/or specifications.

8. The method of claim 2, wherein the enterprise and/or supply chain is a supply chain comprising different members, each member being a manufacturer and/or supplier, the supply chain having unaffiliated and/or independent members and wherein the platform monitors securely and simultaneously multiple supply chains for different products with performance information collected for each monitored supply chain being maintained confidential to one or more of the unaffiliated and/or independent members of the respective monitored supply chain.

9. A system comprising:
a processor; and
a memory coupled with and readable by the processor and storing therein a set of instructions which, when executed by the processor, causes the processor to manage resources of an enterprise by:
locating physical resources other than inventory in a supply chain and/or logistics operation of an enterprise, the physical resources other than inventory comprising physical plant facilities, equipment, and employees;
monitoring the physical resources other than inventory in the supply chain and/or logistics operation of the enterprise;
managing the physical resources other than inventory in the supply chain and/or logistics operation of the enterprise according to a multi-tier model, the multi-tire model comprising at least a tier 1 control tower, tier 2 product assembler, tier 3 part or component manufacturer, and tier 4 material supplier;
managing enterprise and/or supply chain operations of and services performed by one or more of product innovation, engineering, supply chain, and logistics by:
reading a code or identifier associated with inventory as inventory is received and shipped, the code or identifier being one or more of a universal product code, radio frequency identifier, and electronic product code;
collecting and/or storing supply chain and/or logistics operation performance information based on inventory information received from the plurality of readers;
verifying accuracy of scheduled inventory delivery times;
providing estimates of inventory delivery times;
identifying potential manufacturing and delivery problems;
identifying the effects of expected and unexpected events on supply chain and/or logistics performance; and
generating recommended changes to one or more relationships between one or more tiers in the multi-tier model based on the identified effects of the expected and unexpected events; and
providing enterprise and/or supply chain information received from the physical infrastructure and end-to-end services reporting systems and the generated recommended changes to one or more client communication devices.

10. The system of claim 9, wherein the physical resources comprise one or more of physical plant, equipment, employees, consultants, and contractors located in different countries.

11. The system of claim 9, wherein the end-to-end services reporting system manages services and operations performed by the physical infrastructure structure in plural of the following areas: product innovation, engineering, logistics, and supply chain configuration and performance.

12. The system of claim 11, wherein the system manages information related to the physical infrastructure and end-to-end services and provides, through one or more security protocols, one or more of (a) real-time visibility into the information based on access privileges of a requestor, (b) identify and proactively address risk, (c) provide applications to provide services useful in execution of the end-to-end services data processing structure, and/or (d) provide cloud-based access by client communication devices and wherein the client communication devices comprise personal, laptop, and tablet computers, smart phones and other cellular devices, personal digital assistants, and/or enterprise or organization communication devices.

13. The system of claim 12, wherein the information is provided internally within the enterprise, externally to unaffiliated customers of the enterprise, and externally to unaffiliated suppliers independent of the enterprise.

14. The system of claim 12, wherein the system provides cloud-based access by client communication devices and wherein the information is filtered and display formatted properly to reflect the requirements and restrictions of each client communication device, thereby providing communication device awareness.

15. The system of claim 10, further comprising a plurality of the following steps:
enforcing provisions and policies adopted by a network administrator to prevent and monitor unauthorized access, misuse, modification, or denial of a trusted network and/or trusted network-accessible resources;
identifying problems or choke points or bottlenecks in the supply chain and/or logistics operation(s) and wherein the recommended changes provide greater reliability, more reliable and faster material and/or part and/or component and/or product manufacture and delivery cycles, more material turns, and reduced cost and waste;
monitoring long term contract and spot market prices and/or costs on a selected object comprising one or more of materials and/or parts and/or components and/or products, labor, physical facilities, transportation or shipment, and generating, by the cost monitoring module, alarms or notifications when the monitored prices change upwards or downwards beyond specified thresholds and/or providing, by the cost monitoring module, pricing or cost information to a supply chain and logistics analyzer for use in evaluating and recommending changes to the selected supply chain or logistics operation;
providing product or component design services, product or component design scheduling, and/or monitoring of product or component design activities;
receiving requests for information, directing the requests to a selected services module, receiving a response, determining the features and capabilities of the communication device originating the request, filtering and formatting the response according to predetermined rules, to comply with the features and capabilities of the communication device, and forwarding the filtered and formatted response to the communication device;
identifying, protecting, and/or tracking patent protection of innovative ideas, inventions, modifications, adaptations, improvements, trade secrets, and other valuable information; and
monitoring a selected activity and determining and assigning, by the risk manager, a risk parameter to a selected activity failing to satisfy one or more requirements, objectives, and/or specifications.

16. The system of claim 10, wherein the enterprise and/or supply chain is a supply chain comprising different members, each member being a manufacturer and/or supplier, the supply chain having unaffiliated and/or independent members and wherein the platform monitors securely and simultaneously multiple supply chains for different products with performance information collected for each monitored supply chain being maintained confidential to one or more of the unaffiliated and/or independent members of the respective monitored supply chain.

17. A non-transitory, computer-readable medium comprising a set of instructions stored therein which, when executed by a processor, causes the processor to manage resources of an enterprise by:
locating physical resources other than inventory in a supply chain and/or logistics operation of an enterprise, the physical resources other than inventory comprising physical plant facilities, equipment, and employees;
monitoring the physical resources other than inventory in the supply chain and/or logistics operation of the enterprise;
managing the physical resources other than inventory in the supply chain and/or logistics operation of the enterprise according to a multi-tier model, the multi-tire model comprising at least a tier 1 control tower, tier 2 product assembler, tier 3 part or component manufacturer, and tier 4 material supplier;
managing enterprise and/or supply chain operations of and services performed by one or more of product innovation, engineering, supply chain, and logistics by:
reading a code or identifier associated with inventory as inventory is received and shipped, the code or identifier being one or more of a universal product code, radio frequency identifier, and electronic product code;
collecting and/or storing supply chain and/or logistics operation performance information based on inventory information received from the plurality of readers;
verifying accuracy of scheduled inventory delivery times;
providing estimates of inventory delivery times;
identifying potential manufacturing and delivery problems;
identifying the effects of expected and unexpected events on supply chain and/or logistics performance; and
generating recommended changes to one or more relationships between one or more tiers in the multi-tier model based on the identified effects of the expected and unexpected events; and
providing enterprise and/or supply chain information received from the physical infrastructure and end-to-end services reporting systems and the generated recommended changes to one or more client communication devices.
